(19) United States
(12) Patent Application Publication
(10) Pub. No.: US 2024/0167850 A1
(43) Pub. Date: May 23, 2024

(54) SENSOR SYSTEM FOR DETERMINING A RELATIVE ANGULAR POSITION, A METHOD FOR MANUFACTURING A MAGNETISED BODY, AND A METHOD USING SUCH A SENSOR

(71) Applicant: ELECTRICFIL AUTOMOTIVE, Beynost (FR)

(72) Inventor: Nikola JERANCE, Lyon (FR)

(73) Assignee: ELECTRICFIL AUTOMOTIVE, Beynost (FR)

(21) Appl. No.: 18/550,521

(22) PCT Filed: Mar. 24, 2022
(86) PCT No.: PCT/FR2022/050550

§ 371 Date: Sep. 14, 2023

(30) Foreign Application Priority Data
Mar. 25, 2021 (FR) 2102990

(51) Int. Cl. G01D 5/14

(52) U.S. Cl. CPC G01D 5/145; G01D 2205/80

(57) ABSTRACT

A sensor system having a permanent magnet for a sensor for determining a relative angular position (Ω(t)), whose magnetization vector (M(P)) at a point (P) presents, in orthogonal projection on a plane perpendicular to its main axis (A′), a projected vector whose relative orientation (φrp(θ(P))) with respect to the particular radial segment (SRP) at this point (P) is a continuously variable function of the angular position (θ(P)) of the point (P), periodic function having an even integer (Np) greater than or equal to 2 of angular periods (T) over the 360° about the main axis (A′), with a positive variation of the relative orientation (φrp(θ(P))) as a function of a positive variation of the angular position (θ(P)) of the point (P); a method implementing such a sensor system; and a method for manufacturing a magnetized body.

### TECHNICAL FIELD

The invention relates to a sensor for determining a relative angular position of a first part with respect to a second part about an axis of rotation. It also relates to a method for determining a relative angular position, implementing such a sensor. It also relates to a method for manufacturing a magnetized body for a system for determining such a relative angular position.

The technical advantages of the magnetic sensor systems are well known. They can be produced at relatively low cost, they are not subject to significant mechanical wear, and they are insensitive to moisture and non-magnetic dirt (dust, oil, etc.). Thanks to these advantages, the magnetic sensor systems are often used in automotive applications.

A magnetic angular position sensor system includes at least one permanent magnet and magnetic field measurement elements, the sensor system being provided to measure the relative angular position of the measurement element(s) with respect to the magnetized body, about the axis of rotation.

In a practical application, the mechanism to be monitored includes a first part and a second part which are movable in rotation with respect to each other. The magnetized body is made secured to the first part, or integrated into it, while the measurement elements are made secured to the second part of the mechanism, and the sensor system makes it possible to determine the relative angular position of the two parts of the mechanism.

In some cases, it is desired to be able to measure the relative angular position over a maximum angular stroke between the two parts, which may be 45°, 90° or even 180°.

Typically, in an application in the automotive field, such sensor systems are used to determine the relative angular position of an actuator for a member of a motor vehicle, for example an actuator in an automatic or robotized gearbox.

The invention is intended to solve problems related to the practical implementation of the sensor systems, which are often intended to be integrated into a constrained space, with a limited available volume. More particularly, the invention is intended to solve the problems related to the presence of ferromagnetic parts or other sources of disturbance of the magnetic field in the vicinity of the sensor system, which can reduce the accuracy of the determination of the angular position.

### PRIOR ART

Document WO-2014/029885 describes a sensor system having a permanent magnet with an axial magnetization presenting at least two pairs of poles (north-south), with elements for measuring the magnetic field which are in a plane perpendicular to the axis of rotation, axially facing the magnet. The angular position of the magnet is obtained from the differences in magnetic field in the positions spaced by 180° magnetic, thus making it possible to overcome the external magnetic field. The disadvantage of this solution is the lack of robustness with respect to the mounting tolerances and to the dynamic clearance of the mechanical parts, in particular due to the decrease of the magnetic field along the axial dimension.

Document US-2017/0254671 describes a sensor system using Halbach magnetization, which makes it possible to have a shielding around the sensor with the permanent magnet which creates a magnetic field inside the movable part. The disadvantage of this solution is the cost associated with the shielding as well as its weight and bulk.

The invention therefore aims to propose a new design of a magnetized body and of a sensor system using such a magnetized body that make it possible to obtain an accurate and reliable determination of a relative angular position. This determination must be able to be very insensitive to the presence of an external magnetic field. This determination must present a good robustness with respect to possible inaccuracies as to the relative position of the magnetized body and of the measurement elements of the sensor system in the axial direction of the axis of rotation of the sensor system. The sensor system must be of a small space requirement. The magnetized body and the sensor system must be able to be produced in large series under acceptable economic conditions for applications such as those envisaged in the field of motor vehicles.

### DISCLOSURE OF THE INVENTION

The invention relates to a sensor system for determining a relative angular position of a first part with respect to a second part about an axis of rotation, the system comprising:
a permanent magnet having a magnetized body with a magnetized body in the form of a tubular portion symmetrical about a main axis of the magnetized body, the permanent magnet being:
such that the magnetized body has a permanent magnetization such that, for any point of the magnetized body on a given circle about the main axis, each point of the magnetized body on this given circle having an angular position defined by the angle formed, about the main axis and with respect to a fixed reference axis of the permanent magnet, by a particular radial segment originating from the main axis and passing through this point, the magnetization vector at a point of the given circle presents, in orthogonal projection on a plane perpendicular to the main axis, a projected vector whose relative orientation with respect to the particular radial segment at this point is a continuously variable function according to a law of variation of the relative orientation as a function of the angular position of the point of the magnetized body,
such that the law of variation of the relative orientation of the magnetization vector is a periodic function presenting an even integer greater than or equal to 2 of angular periods over the 360° of the magnetized body about the main axis,
and such that the law of variation of the relative orientation of the magnetization vector implies a positive variation of the relative orientation of the projected vector, in orthogonal projection on a plane perpendicular to the main axis, of the magnetization vector at a point, with respect to the particular radial segment, as a function of a positive variation of the angular position of the point of the magnetized body,
the permanent magnet being disposed such that the main axis of the magnetized body coincides with the axis of rotation, disposed such that the main axis of the magnetized body coincides with the axis of rotation;
a primary pair of measurement elements comprising a first primary measurement element making it possible to determine, at a first primary measurement point, a first primary component of the magnetic induction according to a primary measurement vector perpendicular to the axis of rotation, and comprising a second primary measurement element making it possible to determine, at a second primary measurement point, a second primary component of the magnetic induction according to the same primary measurement vector, the first primary measurement point and the second primary measurement point being points distinct from each other on the same primary diametrical segment with respect to the axis of rotation and being located inside the internal volume delimited by the magnetized body, and the primary measurement vector forming, with respect to the primary diametrical segment, a relative primary measurement angle;
a secondary pair of measurement elements comprising a first secondary measurement element making it possible to determine, at a first secondary measurement point, a first secondary component of the magnetic induction according to a secondary measurement vector perpendicular to the axis of rotation, and comprising a second secondary measurement element making it possible to determine, at a second secondary measurement point, a second secondary component of the magnetic induction according to the same secondary measurement vector, the first secondary measurement point and the second secondary measurement point being points distinct from each other on the same secondary diametrical segment with respect to the axis of rotation and being located inside the internal volume delimited by the magnetized body, and the secondary measurement vector forming, with respect to the secondary diametrical segment, a relative secondary measurement angle;
the system being arranged so that the sum of, on the one hand, the angular deviation between the relative secondary measurement angle and the relative primary measurement angle with, on the other hand, the angular deviation, multiplied by the number of periods of the law of variation of the relative orientation of the magnetization vector as a function of the angular position of the point of the magnetized body, between the secondary diametrical segment and the primary diametrical segment, is non-zero and different from a multiple of 180 degrees, the sensor system comprising an electronic calculation unit programmed to calculate a value representative of the relative angular position of the first part with respect to the second part, based on a calculation of the arc-tangent of a ratio between, on the one hand, a difference between the two primary components and, on the other hand, a difference between the two secondary components, ratio in which each difference is weighted as a function of the distance, for the considered difference, between the corresponding measurement points and the axis of rotation.

A sensor system according to the invention may further comprise one or more of the following optional characteristics, taken alone or in combination.

In some cases, the sensor system is arranged so that the sum of, on the one hand, the deviation between the relative secondary measurement angle and the relative primary measurement angle with, on the other hand, the angular deviation, multiplied by the number of periods of the law of variation of the relative orientation of the magnetization vector as a function of the angular position of the point of the magnetized body, between the secondary diametrical segment and the primary diametrical segment is equal, modulo 360 degrees, to 90 degrees or to 270 degrees.

In some cases, the sensor system is arranged so that the relative secondary measurement angle and the relative primary measurement angle are equal, and the angular deviation between the secondary diametrical segment and the primary diametrical segment is a quarter of an angular period of the law of variation of the relative orientation of the magnetization vector, modulo the half angular period of the law of variation of the relative orientation of the magnetization vector. In other cases, the sensor system is arranged so that the primary diametrical segment and the secondary diametrical segment are coincident and so that the primary measurement vector and the secondary measurement vector are orthogonal. In some variants of such other case, the first primary measurement point and the first secondary measurement point are coincident. In some variants of such other cases, the second primary measurement point and the second secondary measurement point are coincident.

In some cases, the first primary measurement point and the second primary measurement point are arranged at the same distance on each side of the axis of rotation.

In some cases, the first secondary measurement point and the second secondary measurement point are arranged at the same distance on each side of the axis of rotation.

In some cases, the first primary measurement point and the second primary measurement point are arranged at the same first distance from the axis of rotation, and the first secondary measurement point and the second secondary measurement point are arranged at the same first distance from the axis of rotation.

In some cases, the two measurement points of the primary pair and/or of the secondary pair of measurement elements are arranged in the same plane perpendicular to the axis of rotation.

In some cases, the two measurement points of the primary pair and/or of the secondary pair of measurement elements are arranged in the same plane perpendicular to the axis of rotation which is equidistant from the axial ends of the magnetized body.

In some cases, the magnetized body has a planar magnetization such that, at any point of the magnetized body, the magnetization vector at this point is parallel to a magnetization plane perpendicular to the main axis.

In some cases, on a given circle about the main axis, the law of variation of the relative orientation of the magnetization vector is a bijective law over an angular period of the law of variation of the relative orientation of the magnetization vector.

In some cases, on a given circle about the main axis, the law of variation of the relative orientation of the magnetization vector implies a 360° variation of the relative orientation of the projected vector, in orthogonal projection on a plane perpendicular to the main axis, of the magnetization vector at a point of the given circle, for a variation of the angular position of the point of the magnetized body corresponding to an angular period of the law of variation of the relative orientation of the magnetization vector.

In some cases, on a given circle about the main axis, the law of variation of the relative orientation of the magnetization vector is a law of linear variation as a function of the angular position of the point of the magnetized body.

In some cases, the magnetized body is a continuous body over 360° about the main axis. In other cases, the magnetized body is formed of elementary magnetized bodies juxtaposed over 360° about the main axis.

In some cases, the magnetized body is a body in the form of a tubular portion of revolution about the main axis.

In some cases, the magnetized body is a body in the form of a cylindrical tubular portion about the main axis.

The invention also relates to a method for determining a relative angular position of a first part with respect to a second part over an angular stroke about an axis of rotation, characterized in that:
the first part is equipped with a permanent magnet having any one of the characteristics listed above;
determining, at a first primary measurement point, a first primary component of the magnetic induction according to a primary measurement vector perpendicular to the axis of rotation and, at a second primary measurement point, a second primary component of the magnetic induction according to the same primary measurement vector, the first primary measurement point and the second primary measurement point being points distinct from each other on the same primary diametrical segment with respect to the axis of rotation and being located inside the internal volume delimited by the magnetized body, and the primary measurement vector forming, with respect to the primary diametrical segment, a relative primary measurement angle;
determining, at a first secondary measurement point, a first secondary component of the magnetic induction according to a secondary measurement vector perpendicular to the axis of rotation and, at a second secondary measurement point, a second secondary component of the magnetic induction according to the same secondary measurement vector, the first secondary measurement point and the second secondary measurement point being points distinct from each other on the same secondary diametrical segment with respect to the axis of rotation and being located inside the internal volume delimited by the magnetized body, and the secondary measurement vector forming, with respect to the secondary diametrical segment, a relative secondary measurement angle;
in that the sum of, on the one hand, the angular deviation between the relative secondary measurement angle and the relative primary measurement angle with, on the other hand, the angular deviation, multiplied by the number of periods of the law of variation of the relative orientation of the magnetization vector as a function of the angular position of the point of the magnetized body, between the secondary diametrical segment and the primary diametrical segment is non-zero and different from a multiple of 180 degrees, and in that a value representative of the relative angular position of the first part with respect to the second part is calculated, based on a calculation comprising, on the one hand, a difference between the two primary components and, on the other hand, a difference between the two secondary components.

In some cases, such a method comprises the calculation of the arc-tangent of a ratio between, on the one hand, the difference between the two primary components and, on the other hand, the difference between the two secondary components, ratio in which each difference is weighted as a function of the distance, for the considered difference, between the corresponding measurement points and the axis of rotation.

In some cases, such a method is implemented with a sensor system as presented above.

The invention also relates to a method for manufacturing a magnetized body for a system for determining a relative angular position of a first part with respect to a second part about an axis of rotation, the method comprising providing a body of magnetizable material having a form of a tubular portion symmetrical about a main axis of the body of magnetizable material, the body of magnetizable material thus having an inner surface and a length in the direction of the main axis, characterized in that the method includes:
the disposition, in the internal volume delimited by the body of magnetizable material, radially in the vicinity of the inner surface of the body of magnetizable material and facing the body of magnetizable material over the length of the body of magnetizable material, of a pattern of parallel electrical conductors comprising a number of bundles of parallel electrical conductors, the number of bundles of parallel electrical conductors being a non-zero multiple of 4, each electrical conductor having an orientation parallel to the main axis and extending, in the direction of the main axis, over a length at least equal to the length of the body of magnetizable material, and each bundle being comprised in a distinct angular sector about the main axis, the measurement of the angular sector of each bundle being equal to 360 degrees of angle divided by the number of bundles, the bundles 24 being angularly offset from each other about the main axis;
the flow of an electric current in the bundles of parallel electrical conductors, the direction of flow of the current, defined in a fixed reference frame with respect to the body of magnetizable material, being identical in all the parallel electrical conductors of the same bundle, and being inverse in two angularly adjacent bundles, thus forming one or more outgoing bundles in which the current flows in a first direction, and one or more ingoing bundles in which the current flows in a second direction, opposite to the first one, the current flowing in the bundles being able to generate, around the pattern and in the body of magnetizable material, a magnetization magnetic field suitable for magnetizing the body of magnetizable material.

A method according to the invention can further comprise one or more of the following optional characteristics, taken alone or in combination.

In some cases, the disposition of the parallel electrical conductors in each bundle is identical by means of a rotation, between two angularly consecutive bundles, by an angle equal to 360 degrees of angle divided by the number of bundles.

In some cases, in a given bundle, the parallel electrical conductors of the bundle are angularly distributed uniformly about the main axis.

In some cases, in a given bundle, the parallel electrical conductors of the bundle are distributed over an arc of a circle centered on the main axis or on several concentric arcs of a circle centered on the main axis.

In some cases, in a given bundle, each parallel electrical conductor of the bundle has a length along the axis of rotation equal to at least 4 times the length of the body of magnetizable material.

In some cases, the parallel electrical conductors of the bundles are formed by portions of at least one winding of a conductive wire along which at least one conductor of an outgoing bundle, a connecting portion and a conductor of an ingoing bundle, another connecting portion and another conductor of an outgoing bundle, repeatedly follow each other.

In some cases, the body of magnetizable material is a body in the form of a tubular portion of revolution about the main axis.

In some cases, the body of magnetizable material is a body in the form of a cylindrical tubular portion about the main axis.

### BRIEF DESCRIPTION OF THE DRAWINGS

FIG. 1 is a perspective view illustrating one possible embodiment for the geometry of a permanent magnet according to the invention.

FIG. 2 schematically illustrates a first embodiment of a sensor system according to the invention, comprising a permanent magnet as illustrated in FIGS. 3 to 5, having a law of variation of the relative orientation of the magnetization vector which has 2 angular periods over the 360° of the magnetized body.

FIG. 3 schematically represents, in top view, one embodiment of a permanent magnet as used in the sensor system of FIG. 2, with an illustration of the magnetization vector in different points of the magnetized body distributed at 360° on a circle of given radius about the main axis of the magnetized body, for a law of variation of the relative orientation of the magnetization vector having two angular periods over the 360° of the magnetized body about the main axis.

FIG. 4 schematically illustrates one embodiment of a method for manufacturing the permanent magnet of FIG. 3.

FIG. 5 schematically illustrates the magnetic induction field Bm created by the permanent magnet of FIG. 3 outside the magnetized body, in particular in the internal volume delimited by the magnetized body.

FIG. 6 is a view similar to that of FIG. 4, for the production of a permanent magnet in which the law of variation of the relative orientation of the magnetization vector has four angular periods on the 360° of the magnetized body.

FIG. 7 is a view similar to that of FIG. 5, schematically illustrating the magnetic induction field Bm created by a magnetized body manufactured according to FIG. 6 outside the magnetized body.

FIG. 8 schematically illustrates another embodiment of a sensor system according to the invention.

FIG. 9 schematically illustrates another embodiment of a sensor system according to the invention.

FIG. 10 schematically illustrates another embodiment of a sensor system according to the invention.

FIG. 11 schematically illustrates another embodiment of a sensor system according to the invention.

FIG. 12 schematically illustrates another embodiment of a sensor system according to the invention.

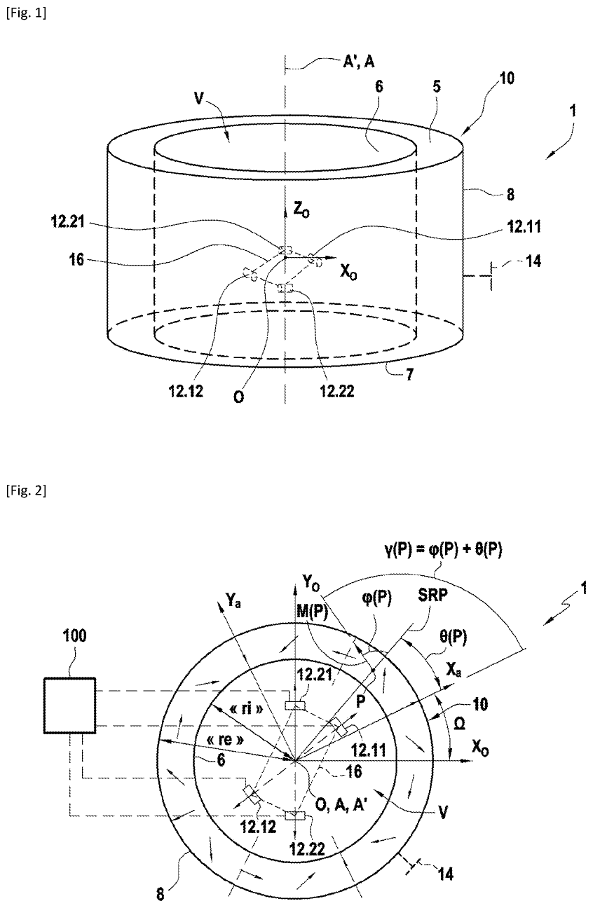

### DESCRIPTION OF THE EMBODIMENTS

The figures illustrate different embodiments of a permanent magnet and different embodiments of a magnetic position sensor system 1 allowing the determination of a relative angular position Ω(t) of a first part 14 with respect to a second part 16 about an axis of rotation A.

In all cases, the sensor system 1 is designed to determine the relative angular position Ω(t) of two parts 14, 16 which are capable of moving relative to one another along a rotational movement about the axis of rotation A. In the examples illustrated, the two parts 14, 16 are illustrated symbolically. Preferably, there is no other axis of relative displacement. It is considered that the two parts 14, 16 have no relative movement in the radial directions with respect to the axis of rotation A. The sensor system 1 can thus for example be used to detect the angular position of an output shaft of a rotary actuator.

The sensor system 1 includes a permanent magnet having a magnetized body 10 with permanent magnetization, and measurement elements 12.11, 12.12, 12.21, 12.22 of the magnetic induction. In some embodiments, it will be provided that several measurement elements are grouped together in one or more measurement cells. In a practical application, the magnetized body 10 is intended to be fixed to a first part 14 of a mechanism, for example the rotary output shaft of an actuator for a transmission member of a motor vehicle, which is movable with respect to a second part 16 of the mechanism, for example a fixed part of the structure of the vehicle or a support part of the sensor system 1.

Typically, the magnetized body 10 is arranged on a rotary shaft forming the first part 14 in a configuration in which the magnetized body is arranged at the end of the shaft, at one longitudinal end thereof.

The sensor system 1 is provided to determine the relative angular position Ω(t) of the magnetized body 10 with respect to the measurement elements 12.11, 12.12, 12.21, 12.22 about the axis of rotation A, the measurement elements 12.11, 12.12, 12.21, 12.22 having a fixed position with respect to each other and a fixed position with respect to the second part 16. The relative movement between the magnetized body 10 and the measurement elements 12.11, 12.12, 12.21, 12.22, which is a simple rotation in the example considered, can therefore be described in an orthogonal reference frame (O, Xo, Yo, Zo), the base vectors Xo and Yo being contained in a plane perpendicular to the axis of rotation A, the point of origin 0 being a point on the axis of rotation A, and the directions of the base vectors Xo and Yo being arbitrary but orthogonal to each other, and fixed with respect to the second part 16, as illustrated for example in FIG. 2. As a result, the base vector Zo is parallel to the axis of rotation A. This reference frame (O, Xo, Yo, Zo) is therefore fixed with respect to the second part 16 and with respect to the measurement elements 12.11, 12.12, 12.21, 12.22, and will hereinafter be referred to as measurement reference frame. In such a measurement reference frame, the first part 14 is movable and the second part 16 is fixed, but this is arbitrary insofar as only a relative movement is considered between the two parts 14, 16.

The magnetized body 10 has a geometry in the form of a tubular portion symmetrical about a main axis A′ of the magnetized body 10. It is therefore in the form of a volume formed between an inner surface 6 and an outer surface 8, each of which is symmetrical about the main axis A′. The inner surface 6 is surrounded by the outer surface 8. The main axis A′ of the magnetized body 10 is therefore an axis of symmetry for the magnetized body 10. Within the framework of the sensor system, and therefore within the framework of the method, the magnetized body 10 is preferably arranged so that its main axis A′ coincides with the axis of rotation A of the relative movement between the first part 14 and the second part 16. However, a radial offset between the two axes is possible, whether it is intentional or results from mounting inaccuracies, for example due to geometric tolerances of the constituent parts of the mechanism or of their assembly. In the following, it is considered that, in the sensor system 1, the main axis A′ coincides with the axis of rotation A.

In the various examples illustrated, the magnetized body 10 has a geometry in the form of a cylindrical tubular portion about the main axis A′, symmetrical with respect to the main axis A′, that is to say a volume formed between two inner 6 and outer 8 cylindrical surfaces, each of which is generated by a straight generatrix, parallel to the main axis A′, following a closed curve which extends 360° about the main axis A′. More specifically, it can be provided, which is the case in the examples illustrated, that the magnetized body 10 has a geometry in the form of a cylindrical tubular portion of revolution about the main axis A′. In such a case, in section by a plane perpendicular to the main axis A′, the two inner 6 and outer 8 cylindrical surfaces of the magnetized body 10 have a circular shape. As an alternative to such a shape of revolution, it could be provided that the magnetized body 10 has, in section by a plane perpendicular to the main axis A′, a polygonal geometry symmetrical about the main axis A′, preferably with a number of sides greater than or equal to 6, preferably greater than or equal to 8, and preferably with sides of equal dimensions between them.

The magnetized body 10 in the form of a tubular portion symmetrical about a main axis A′ of the magnetized body delimits an internal volume V, which, as will be seen, must be dimensioned to accommodate the magnetic induction measuring elements. This internal volume V will therefore preferably include completely, in the radial direction with respect to the main axis A′, a cylindrical inscribed volume of revolution about the main axis A′ having a minimum radius which will be for example ranging from 5 to 10 millimeters. In the case of a magnetized body 10 having a geometry in the form of a cylindrical tubular portion of revolution about the main axis A′, the inner cylindrical surface 6 of the magnetized body 10 therefore has a radius “ri” ranging from 5 at 10 millimeters. Of course, it is possible to design a magnetized body 10 having an internal volume V of greater radial dimension, but this will harm the compactness of the sensor system. However, a larger dimension could be necessary as a function of the size of the components that form the measurement elements, and as a function of the positioning tolerances to avoid mechanical interference.

Of course, the magnetized body 10 has a thickness in a radial direction with respect to the main axis A′. Preferably, for any section of the magnetized body 10 by a plane perpendicular to the main axis A′, the radial thickness of the magnetized body 10 is constant over 360° about the main axis A′. In some applications, this thickness may be ranging from 2 to 10 millimeters, preferably ranging from 2 to 6 millimeters. A greater thickness could however make it possible to produce a magnetized body with a less efficient magnetic material, therefore less expensive, to obtain the desired magnetic induction values.

Thus, in total, the magnetized body 10 can be inscribed in an outer cylindrical shell of revolution about the main axis A′ which has an external radius “re” of less than 25 mm, or even in some applications less than 15 mm, which makes it possible to have a particularly compact sensor system 1 in the radial direction. Thus, the magnetized body 10 can be inscribed in an outer cylindrical shell of revolution about the main axis A′ which has an outer radius “re” which can be ranging from 8 millimeters to 20 millimeters. For other applications, a greater external radius can be implemented. In the case of a magnetized body 10 having a geometry in the form of a cylindrical tubular section of revolution about the main axis A′, the outer cylindrical surface 8 of the magnetized body 10 can therefore have a radius “re” of less than 25 mm, or even in some applications less than 15 mm, par example ranging from 8 to 20 millimeters.

The magnetized body 10 is delimited axially by two opposite end faces 5, 7. Preferably, the two opposite, upper 5 and lower 7, end faces 5, 7 of the magnetized body 10 are planar surfaces each contained in a plane perpendicular to the main axis A′, therefore, in the sensor system 1, perpendicular to the axis of rotation A. The axial dimension of the magnetized body 10, between its two opposite end faces 5, 7, is for example ranging from 4 millimeters to 20 millimeters.

The magnetized body 10 can be a continuous body over 360° about the axis of rotation, that is to say formed from a single piece. However, it is possible as an alternative to provide that the magnetized body is formed of elementary magnetized bodies juxtaposed over 360° about the main axis A′ of the magnetized body, the elementary magnetized bodies being distinct bodies. The elementary magnetized bodies can then be assembled to form the annular body, for example by being bonded to each other and/or by being assembled on a support part.

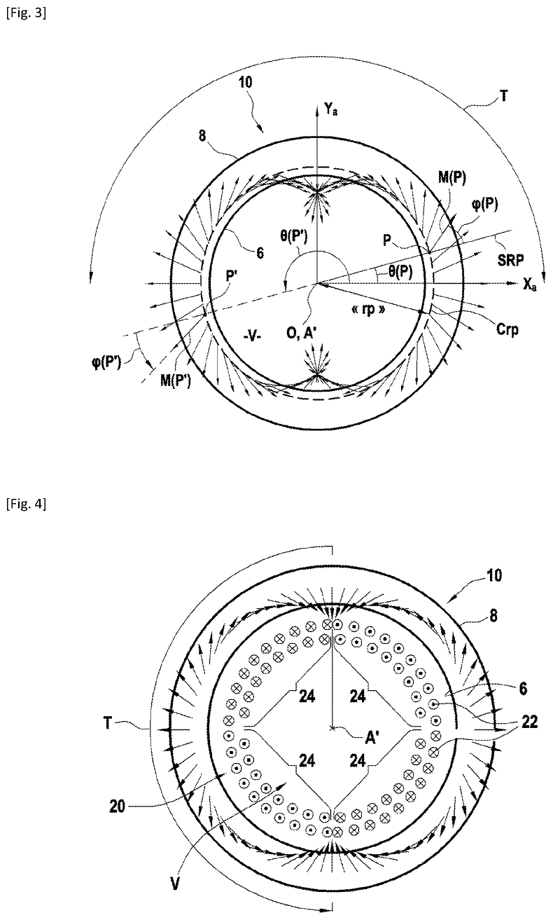

As illustrated in FIG. 3 for the first exemplary embodiment, the magnetized body 10 has a permanent magnetization. Any point P of the magnetized body 10 is considered. Any point P of the magnetized body 10 can be considered to be located on a given circle Crp about the main axis A′. Each point P of the magnetized body 10 on this given circle Crp, whatever the given circle Crp, has an angular position which is defined by the angle θ(P) formed, about the main axis A′, between a fixed reference axis Xa of the permanent magnet and a particular radial segment SRp originating from the main axis and passing through this point P. The reference axis Xa is perpendicular to the main axis A′, and therefore secant with the main axis A′. The reference axis Xa can be one of the base axes of an orthogonal reference frame (O′, Xa, Ya, Za), hereinafter called reference frame of the permanent magnet, the base vectors Xa and Ya being contained in a plane perpendicular to the main axis A′, the point of origin 0′ being a point on the main axis A′, which is for example located at mid-length of the magnetized body 10 in the direction of the main axis A′. As part of a sensor system, the point of origin 0′ of the reference frame of the permanent magnet can coincide with the point of origin 0 of the measurement reference frame. The directions of the base vectors Xa and Ya are orthogonal to each other, and fixed with respect to the magnetized body 10. As a result, the base vector Za is parallel to the main axis A′. The orientation of the radial base vector Xa can be arbitrary with respect to the magnetized body 10. In this reference frame of the permanent magnet, the first part 14 is fixed and the second part 16 is movable, but this is arbitrary insofar as only a relative movement between the two parts 14, 16 is considered.

As a definition of the relative angular position ((t) of the two parts 14, 16, at a given moment, it is possible to arbitrarily choose the angle which is formed between the fixed reference axis Xa of the permanent magnet and a base vector Xo of the orthogonal reference frame (O, Xo, Yo, Zo) which is fixed with respect to the second part 16. This angle Ω(t) is therefore in a plane perpendicular to the axis of rotation A and to the main axis A′.

In the present text, the two notions of direction and vector will be distinguished. A vector has a direction, a direction determined according to this direction, and a magnitude. Conversely, a given direction can be traveled in two opposite directions.

It is noted that the particular segment SRp is common for all the points of the magnetized body 10 which have the same angular position about the main axis A′. Each point P of the magnetized body 10 on this given circle Crp is located at a distance rp from the main axis A′, distance rp which is identical for all the points on the given circle Crp, the value rp therefore being the radius of this given circle Crp. A point P can therefore be defined by its polar coordinates P(rp, θ(P)). For any point P of the magnetized body 10 on the given circle Crp, the magnetization vector M(P) at such a point P of the given circle Crp presents, in orthogonal projection on a plane perpendicular to the main axis A′, a projected vector whose relative orientation φ(P), with respect to the particular radial segment SRp at this point P, is a function which is continuously variable according to a law of variation φ(P), which is hereinafter referred to as the law of variation of the relative orientation of the magnetization vector, and which is a function of the angular position θ(P) of the point P of the magnetized body 10. As will be seen later, the law of variation of the relative orientation of the magnetization vector can also be a function of the distance rp from the point P to the main axis A′, distance rp which is identical for all points on the given circle Crp. In this case, it is possible to generalize by stipulating that the law of variation of the relative orientation φ(P) of the magnetization vector is a function of the angular position θ(P) which can therefore be expressed in the form of φ(rp, θ(P)). On a given circle Crp of radius rp about the main axis A′, the law of variation of the relative orientation φ(P) of the magnetization vector can therefore be expressed in the form of φrp(θ(P)).

The relative orientation φ(P) corresponds to the angle between, on the one hand, the projected vector, in orthogonal projection on a plane perpendicular to the main axis A′, of the magnetization vector M(P) and, on the other hand, the particular radial segment SRp at this point P. The variation of the relative orientation dφrp(θ(P)) is defined as the variation of orientation made by the projected vector, in orthogonal projection on a plane perpendicular to the main axis A′, of the magnetization vector M(P), when shifting by an angular offset dθ(P) on the given circle Crp about the main axis A′.

The law of variation of the relative orientation φrp(θ(P)) of the magnetization vector is a periodic function having an even number Np greater than or equal to 2 of angular periods T over the 360° of the magnetized body 10 about the main axis A′. In other words, for two points P and P′ of the magnetized body 10 which are angularly offset by an angular period T about the main axis A′, and which are located on the same given circle Crp about the main axis A′, therefore at the same distance rp from the main axis A′, the magnetization vectors M(P) and M(P′) present, in orthogonal projection on a plane perpendicular to the main axis A′, the same relative orientation φ(P)=φ(P′) with respect to the corresponding particular radial segment SRp, SRp′. It will however be noted that, except in special cases, the magnetization vectors M(P) and M(P′) at such points will not necessarily have the same absolute orientation with respect to the fixed reference axis Xa of the permanent magnet.

The law of variation of the relative orientation φrp(θ(P)) of the magnetization vector is a continuously variable function over an angular period T. In other words, the relative orientation φrp(θ(P)) of the magnetization vector is a function that varies at any point over an angular period T such that “consecutive” points on the same given circle Crp about the main axis A′, present a relative orientation φrp(θ(P)) of the magnetization vector which is different.

It is noted that when looking at the absolute orientation of the projected vector, in orthogonal projection on a plane perpendicular to the main axis A′, of the magnetization vector M(P), with respect to the fixed reference axis Xa of the permanent magnet, this is defined for each point P on the given circle Crp by the relation γrp(P)=φrp(θ(P))+θ(P). In this way, the absolute orientation of the projected vector, in orthogonal projection on a plane perpendicular to the main axis A′, of the magnetization vector M(P), with respect to the fixed reference axis Xa of the permanent magnet, is also a function which is continuously variable (according to a law of variation of the absolute orientation γ(P)=φ(P)+θ(P)) as a function of the angular position θ(P) of the point P of the magnetized body 10. This law of variation presents an odd number greater than or equal to 3 of angular periods over the 360° of the magnetized body 10 about the main axis A′.

Because the law of variation of the relative orientation φrp(θ(P)) is a periodic function having an even number Np greater than or equal to 2 of angular periods T over the 360° of the magnetized body 10 about the main axis A′, for two points P and P′ of the magnetized body 10 which are symmetrical to each other with respect to the main axis A′, the magnetization vectors M(P) and M(P′) present, in orthogonal projection on a plane perpendicular to the main axis A′, the same direction but an opposite direction.

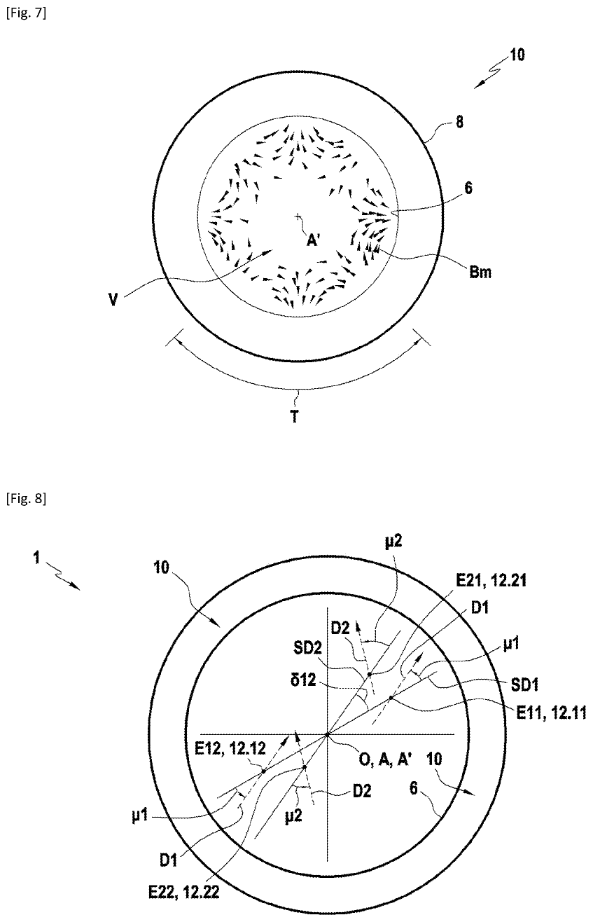

In the example of FIGS. 2 to 5, the law of variation of the relative orientation φrp(θ(P)) of the magnetization vector has 2 angular periods over the 360° of the magnetized body 10 about the main axis A′, each angular period T thus being equal to 180° of mechanical angle. In the example of FIGS. 6 and 7, the law of variation of the relative orientation φrp(θ(P)) of the magnetization vector has 4 angular periods over the 360° of the magnetized body 10 about the main axis A′, each angular period T thus being equal to 90° of mechanical angle.

In the examples illustrated, by moving on a given circle Crp about the main axis A′, the law of variation of the relative orientation φrp(θ(P)) of the magnetization vector implies a 360° variation of the relative orientation φrp(θ(P)) of the projected vector, in orthogonal projection on a plane perpendicular to the main axis, of the magnetization vector with respect to the particular radial segment corresponding to the considered point, for a variation of the angular position of the considered point of the magnetized body 10 corresponding to an angular period T of the law of variation of the relative orientation φrp(θ(P)) of the magnetization vector.

In the example of FIGS. 2 to 5, a 360° variation of the relative orientation φrp(θ(P)) of the magnetization vector M(P) with respect to the corresponding radial segment SRp is therefore observed, for a 180° variation of the angular position of the considered point about the main axis A′. Such a permanent magnet will be particularly useful for applications in which the useful stroke over which it is desired to determine the relative position of the two parts 14, 16 is greater than or equal to 90° and less than 180º.

In the example of FIGS. 6 and 7, a 360° variation of the relative orientation φrp(θ(P)) of the magnetization vector M(P) with respect to the corresponding radial segment SRp is therefore observed, for a 90° variation of the angular position of the considered point of the magnetized body 10 about the main axis A′. Such a permanent magnet will be particularly useful for applications in which the useful stoke over which it is desired to determine the relative position of the two parts 14, 16 is greater than or equal to 45° and less than 90°, in order to exploit a maximum of the variation of the relative orientation φrp(θ(P)) of the magnetization vector M(P) over the useful stroke.

It is noted that it is possible to generally consider that, for any point P and P′ of a magnetized body, the magnetization vectors M(P) and M(P′) have the same magnitude. Indeed, during the magnetization of the magnetized body, it will be generally ensured to magnetize the magnetized body until magnetic saturation. This implies in particular to neglect the variation of magnetization according to the magnetic field in the magnet, which is in general true in the range of normal operation of the magnet.

In the following, it is considered that the magnitude of the magnetization vector M(P) is identical for any point P of the magnetized body 10, in particular for any point P belonging to the same given circle about the main axis A′. In such a case, for such points P and P′ symmetrical to each other with respect to the main axis A′, the magnetization vectors M(P) and M(P′) present, in projection on a plane perpendicular to the main axis A′, parallel projections, of opposite directions, and of the same magnitude.

It will be noted that, for different points of the magnetized body 10 located on the same radial segment originating from the main axis A′, the relative orientation of the magnetization vector can slightly vary as a function of the radius “rp” at which the considered point P is located. This variation is in particular due to the magnetization device which, in practice, often creates a magnetic field having an imperfect “rotation”, but also to the boundary conditions at the level of the inner and outer surfaces 6 and 8 of the magnetized body 10 during the magnetization. However, calculations by simulation have shown that, for different points of the magnetized body 10 located on the same radial segment originating from the main axis A′, the relative orientation of the magnetization vector (as well as the absolute orientation), in orthogonal projection on a plane perpendicular to the main axis A′, varies by less than 10 degrees of angle as a function of the radius “rp” at which the considered point P is located, this variation generally being a continuous variation.

On a given circle Crp about the main axis A′, the law of variation of the relative orientation of the magnetization vector implies a positive variation of the relative orientation φrp(θ(P)) of the projected vector, in orthogonal projection on a plane perpendicular to the main axis, of the magnetization vector M(P) at a considered point P, with respect to the particular radial segment SRp passing through this considered point P, as a function of a positive variation of the angular position of the considered point of the magnetized body about the main axis A′. Positive variation of the angular position of the point of the magnetized body about the main axis is referred to as a variation according to an arbitrary direction about the main axis A′. With this convention, for an elementary variation dθ(P) of the angular position θ(P) of the point P of the magnetized body about the main axis A′, much less than the angular period T of the law of variation of the relative orientation φrp(θ(P)) of the magnetization vector, the elementary variation dφrp(θ(P)) of the relative orientation of the magnetization vector takes place, about an axis parallel to the main axis A′ and passing through the considered point P, in the same arbitrary direction of rotation. Thus we have, at any point P of the magnetized body on this given circle Crp, over an angular period T, dφrp(θ(P))/dθ(P)>=0.

Preferably, on a given circle Crp about the main axis A′, the law of variation of the relative orientation of the magnetization vector implies a non-zero positive variation of the relative orientation φrp(θ(P)) of the projected vector, in orthogonal projection on a plane perpendicular to the main axis, of the magnetization vector M(P) at a considered point P, with respect to the particular radial segment SRp passing through this considered point P, as a function of a non-zero positive variation of the angular position of the considered point of the magnetized body about the main axis A′. Thus, we have preferably at any point (P) of the magnetized body on this given circle Crp, over an angular period T, dφrp(θ(P))/dθ(P)>0, therefore strictly positive.

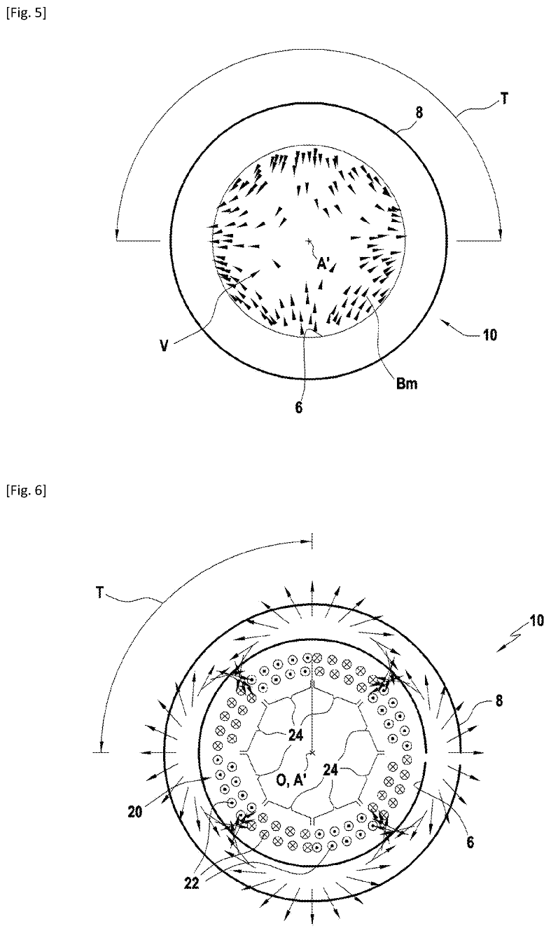

Non-intuitively, this variation in the same direction allows the generation of a magnetic induction field essentially in the internal volume V which is delimited by the magnetized body 10. Thus, as can be seen in FIG. 5 and in FIG. 7, the permanent magnet does not generate any significant magnetic field outside its volume, that is to say at any point located radially beyond its outer surface 8 with respect to the main axis A′. This makes it possible not to pollute the surrounding space with an unwanted magnetic field.

Preferably, the magnetized body 10 has a planar magnetization, that is to say such that, at any point of the magnetized body, the magnetization vector at this point is parallel to a magnetization plane perpendicular to the main axis A′. In such a case, the projected vector, in orthogonal projection on a plane perpendicular to the main axis A′, of the magnetization vector M(P) is coincident with the magnetization vector M(P). In other words, under this condition, the magnetization vector M(P) and its projected vector, in orthogonal projection on a plane perpendicular to the main axis A′, are identical. Knowing that, for a magnetized magnet at the magnetic saturation, the magnitude of the magnetization vector M(P) is almost constant for any point P of the magnetized body, then, for points P and P′ symmetrical to each other with respect to the main axis A′, the magnetization vectors M(P) and M(P′) are parallel, of opposite directions and of the same magnitude, therefore symmetrical vectors.

Of course, this characteristic of flatness is assessed as a function of the generally recognized tolerances in terms of magnetization of the magnetized bodies. The magnetization plane is therefore a theoretical plane. On the one hand, it is known that the magnetization is subject to edge effects which can locally modify the magnetization in the vicinity of the outer surfaces of the magnetized body. At these points, there may not be strict parallelism of the magnetization vector with the magnetization plane which is a theoretical plane. Similarly, it is known that defects in the homogeneity of the magnetic material can locally affect the magnetization. The magnetization plane must therefore be understood as representative of the magnetization at each point of the magnetized body, taken as a whole, taking into account mainly the points that are not affected either by the edge effects or by the defects of homogeneity clearly not desired, therefore in particular the points in the core of the magnetized body.

In the illustrated examples, the case where the magnetization plane is strictly perpendicular to the main axis A′ have been illustrated. It is understood that the notion of strict perpendicularity of the magnetization plane with respect to the main axis A′ must be assessed there also with regard to the usual technique in the field of magnetic fields and in particular of the magnetization of the magnetized bodies. It must still be assessed with regard to the advantages and benefits of the invention, in particular the robustness of the measurement delivered by a sensor system made with such a magnetized body to the relating positioning defects, between the magnetized body and the measurement elements, in the direction of the main axis A′.

Also, within the meaning of the present invention, it will be considered that the magnetization plane is strictly perpendicular to the main axis A′ if it forms with the considered axis an axis less than 5 degrees. It will be considered that the magnetization plane is perpendicular to the main axis A′ if it forms with the considered axis an angle of inclination less than 30 degrees, preferably less than 20 degrees.

Preferably, on a given circle Crp about the main axis A′, the law of variation of the relative orientation φrp(θ(P)) of the magnetization vector is a bijective law over an angular period T of the law of variation of the relative orientation φrp(θ(P)) of the magnetization vector. This bijection relation promotes, in the internal volume V delimited by the magnetized body 10, a magnetic induction field Bm such that it is possible to obtain a relation between on the one hand at least 4 measurements of the magnetic induction in this internal volume V, and on the other hand the relative angular position Ω(t) in rotation between the magnet and the measurement points, which is also a bijective relation over an angular period T. It is thus possible to associate, within an angular period T, a single relative angular position Ω(t) in rotation between the permanent magnet and the measurement points.

Preferably, it will be sought to obtain that, on a given circle Crp about the main axis A′, the law of variation of the relative orientation φrp(θ(P)) of the magnetization vector is a linear law, that is to say, of the type φrp(θ(P))=a0 θ(P)+b0, with a0 a non-zero positive leading coefficient and b0 a constant.

Thus, in the example of FIGS. 2 to 4, with the convention of choosing as a reference axis Xa of the reference frame of the magnet the axis passing through a point at which the relative orientation of the magnetization vector is zero, we have the relation:

φrp(θ(P))=2θ(P)

It will be noted that, in the illustrated embodiments, the magnetized body 10 is a continuous body over 360° about the main axis A′, therefore made in one piece with continuity of material. It will be seen later how the desired magnetization can be achieved in such a continuous body over 360°. However, as a variant, the magnetized body could be formed of elementary magnetized bodies juxtaposed over 360° about the main axis. In such a variant, the magnetization could be made either after the assembly of the elementary magnetized bodies, in a manner similar to what is proposed for a continuous body over 360°, or before the assembly of the elementary magnetized bodies.

A method for manufacturing a magnetized body having the properties above is also proposed.

In this method, a body of magnetizable material 10 having a shape as defined above is provided. The magnetizable material is in particular a ferromagnetic material, in particular hard ferromagnetic, ferrimagnetic or antiferromagnetic material, capable of forming, after controlled magnetization, a permanent magnet. Such materials include alloys, for example of neodymium, iron and boron (Nd2Fe14B) of Samarium and Cobalt (SmCo5 and Sm2Co17), and ferrites, as well as AlNiCo.

For the implementation of the method, there is disposed, as illustrated in FIGS. 4 and 6, in the vicinity of the body of magnetizable material 10, a pattern 20 of parallel electrical conductors 22, each called magnetization conductor 22, comprising several bundles 24 of parallel electrical conductors 22, each oriented along an axis parallel to the main axis A′. A magnetization conductor 22 preferably consists of a wire or a bar made of conductive material, for example copper, elongated along the orientation of the main axis A′.

In the examples illustrated, the magnetization conductors 22 are disposed so as to cross, in the direction of the main axis A′, the internal volume V delimited by the magnetized body 10. The magnetization conductors 22 are disposed preferably in the vicinity of the inner surface 6 of the magnetized body 10.

A bundle 24 of magnetization conductors 22 is called a group of magnetization conductors in which, at a given moment, the current flows in the same direction and in which the magnetization conductors 22 are not separated by a magnetization conductor 22 in which the current flows in another direction, in the reference frame linked to the magnet. A bundle 24 can comprise a single magnetization conductor 22 or, preferably, several magnetization conductors 22, for example in the range from 4 to 40 magnetization conductors 22 for a bundle 24. Different bundles 24 can comprise a different number of magnetization conductors 22.

Each bundle24 is comprised in space in a distinct angular sector about the main axis A′ whose angular measurement is less than or equal to half of an angular period T of the law of variation of the relative orientation φrp(θ(P)) of the magnetization vector desired to be created in the permanent magnet, preferably over an angular range about the main axis A′ which is as close as possible to half of an angular period of the law of variation of the relative orientation φrp(θ(P)) of the magnetization vector. The angular measurement of the angular sector in which each bundle is comprised is equal to 360 degrees of angle divided by the number of bundles. The bundles 24 are angularly offset from each other about the main axis A′. Preferably, two consecutive bundles 24 are directly juxtaposed to each other angularly about the main axis A′. Thus, over an angular period of the law of variation of the relative orientation φrp(θ(P)) of the magnetization vector, two consecutive bundles 24 are disposed, one with magnetization conductors 22 in which, at a given moment, the current flows in the same direction and the other in which the current flows in another direction in the magnetization conductors 22.

In a bundle 24, some of the magnetization conductors 22 or all the magnetization conductors 22 can be contiguous to each other. In this case, it can be provided that the magnetization conductors 22 are electrically insulated from each other, for example by an insulating sheath. In contrast, one or more magnetization conductors 22 of a bundle 24 can be spaced apart transversely from the other magnetization conductors of the same bundle 24, or all the magnetization conductors 22 can be spaced apart from each other. A bundle 24 can comprise an outer shell, for example made of electrically insulating material, surrounding the magnetization conductors 22 of the bundle.

The number of bundles 24 of parallel electrical conductors 22 is a non-zero multiple of 4. More specifically, a bundle 24 of parallel electrical conductors will be advantageously provided for each half-period T/2 of the law of variation of the relative orientation φrp(θ (P)) of the desired magnetization vector in the magnetized body sought to be manufactured. In the example of FIG. 6, to produce a magnetized body 10 having two angular periods of the law of variation of the relative orientation φrp(θ(P)) of the magnetization vector over the 360° of the magnetized body 10, four bundles 24 are thus disposed, each of which extends, in the internal volume V delimited by the magnet body 10, over 90° about the main axis A′. In two of the bundles 24, offset from each other by 180° about the main axis A′, the current flows in a first direction according to the orientation of the magnetization conductors, while in the two other bundles, offset from each other by 180° about the main axis A′ and interposed between the other two, the current flows in a second direction, opposite to the first one. In the example of FIG. 7, to produce a magnetized body 10 having four angular periods of the law of variation of the relative orientation φrp(θ(P)) of the magnetization vector over the 360° of the magnetized body 10, eight bundles 24 are thus disposed, each of which extends, in the internal volume V delimited by the magnet body 10, over 45°. In four of the bundles 24, offset from each other by 90° about the main axis A′, the current flows in a first direction according to the orientation of the magnetization conductors, while in the four other bundles, offset from each other by 90° about the main axis A′ and interposed between the other four, the current flows in a second direction, opposite to the first one.

Typically, the bundles 24 are disposed, for their magnetization conductors 22 the closest to the inner surface 6 of the body made of magnetizable material 10, less than 10 mm from the inner surface 6, even less than 5 mm from the inner surface 6.

The method of course involves the flow of an electric current in the bundles of magnetization conductors 22, the direction of flow of the current being, at a given moment, for example a moment for which the intensity of the current is maximum, identical in all the magnetization conductors 22 of the same bundle 24, and being inverse in two bundles 24 immediately adjacent about the main axis A′.

By this flow of the electric current, it is thus possible to distinguish one or more outgoing bundles 24, forming an outgoing group of bundles, in which, at a given moment, for example a moment for which the intensity of the current is maximum, the current flows in the first direction, and one or more ingoing bundles 24, forming an ingoing group of bundles, in which, at the same given moment, the current flows in the second direction, opposite to the first one.

In this way, the electric current flowing in the bundles 24 is able to generate, around the pattern 20 and therefore in the body of magnetizable material 24, a magnetization magnetic field suitable for magnetizing the body of magnetizable material. In particular, this electric current must have a maximum value of sufficient intensity. By disposing the bundles 24 perpendicularly to the main axis A′, and by alternating the outgoing bundles and the ingoing bundles, it is possible to generate a magnetic field capable of conferring, to the body of magnetizable material, a magnetization as described above.

In particular, the magnetic field created by the pattern of magnetization conductors is preferably able to magnetically saturate the magnetizable material, at all points thereof. Once thus magnetized, the body made of magnetizable material can serve as a body of magnetic material 10 in a method and in a sensor system 1 according to the invention.

For this, the following parameters can be in particular adapted:
intensity of the electric current in a bundle, and therefore in a conductor, by taking into account in particular the maximum intensity;
density of the bundles in conductors;
relative positioning of the bundles and conductors in a bundle;
number of conductors per bundle;
spacing of the bundles with respect to the body of magnetizable material, and in particular with respect to the inner surface 6 of the body of magnetizable material 10;
etc . . .

It is noted that different bundles 24 do not necessarily include the same number of conductors. However, preferably, the disposition of the conductors in each bundle 24 is identical from one bundle to another, by means of a rotation, between two angularly consecutive bundles, by an angle equal to the measurement of the angular sector in which a bundle is contained, i.e. 360 degrees of angle divided by the number of bundles. The bundles 24 will therefore be preferably identical to each other, in particular in number, dimensions and disposition of the magnetization conductors with only an angular offset of half a period between two consecutive bundles 24.

In a given bundle, the magnetization conductors 22 of the bundle 24 are preferably angularly distributed in a uniform manner about the main axis A′. It can be advantageously provided that, in a given bundle, the magnetization conductors 22 of the bundle 24 are distributed over an arc of a circle centered on the main axis or, as in the examples illustrated in FIGS. 4 and 6, over several concentric arcs of a circle centered on the main axis A′. Preferably, the magnetization conductors 22 of the bundle 24 are contained inside a shell surface whose section, in a plane perpendicular to the main axis A′, is a sector of a ring about the main axis A′.

In the outgoing group of bundles 24, on the one hand, and in the ingoing group of bundles 24, on the other hand, it can be provided that several bundles 24, or even all the bundles 24, are electrically powered in parallel. Similarly, in a given bundle 24, it can be provided that several magnetization conductors 22 or all of the magnetization conductors 22 are electrically powered in parallel.

However, preferably, it will be provided that several bundles 24, or all of the bundles 24, including outgoing bundles and ingoing bundles, are electrically connected in series. It can be provided that several magnetization conductors 22, even all of the magnetization conductors 22, including outgoing magnetization conductors and ingoing magnetization conductors, are electrically connected in series to form one or more magnetization coils.

It can thus be provided that the magnetization conductors 22 of the bundles are formed by portions of at least one winding of a coil of a conductive wire along which at least one magnetization conductor 22 of an outgoing bundle, a connecting portion and a magnetization conductor 22 of an ingoing bundle, another connecting portion and another magnetization conductor 22 of an outgoing bundle, repeatedly follow each other. Thus, within a pattern, all of the magnetization conductors 22 can be grouped together in a single coil winding, in two coil windings or in more than two coil windings.

In another embodiment (not represented), a pattern of conductors could be formed of a grating including, on one side of the body made of magnetizable material, a first connecting bar or plate at a first electric potential and, on the other side of the body made of magnetizable material, a second connecting bar or plate at a second electric potential. Each conductor of the pattern could then take the form of a rectilinear segment whose length would correspond to the distance between the bars or plates, each conductor extending between the two bars or plates, and being connected by its two ends respectively to the first and to the second connecting bar or plate.

The magnetization conductors 22 have a length according to their orientation which extends between two power supply heads which can for example each be constituted by the connecting portion as part of a coil, or by a connecting bar or plate as part of a bundle formed by a grating. In the power supply heads, the electric current can flow in a transverse or substantially transverse direction with respect to the orientation of the conductors. It is desirable to limit the magnetic influence of these currents, to limit the disturbances on the magnetization of the body of magnetizable material, and it is therefore desirable that the magnetization conductors have a sufficient length to achieve this goal. The magnetization conductors 22 will thus have an axial length greater than the axial extent of the body of magnetizable material 10, preferably an axial length greater than or equal to 4 times the axial extent of the body of magnetizable material 10.

A permanent magnet as described above generates, outside the magnetized body 10, a magnetic induction field Bm as represented in FIG. 5 or in FIG. 7 for the two exemplary embodiments described above.

This magnetic induction field created by the permanent magnet has, in the internal volume V delimited by the inner surface 6 of the magnetized body 10, a property similar to the one described above regarding the magnetization vector in the magnetized body 10. Any point E of the internal volume V delimited by the inner surface 6 of the magnetized body 10 can be considered as being on a given circle about the main axis A′. Each point E of the internal volume V on this given circle has an angular position defined by the angle formed, about the main axis, between the fixed reference axis of the permanent magnet described above, and a particular radial segment originating from the main axis and passing through this point E. With a permanent magnet having the magnetization above, it can be seen that the magnetic induction Bm generated by the permanent magnet at this point of the given circle presents, in orthogonal projection on a plane perpendicular to the main axis A′, a projected vector whose relative orientation with respect to the particular radial segment at this point is a continuously variable function according to a law of variation of the relative orientation, with respect to the particular radial segment originating from the main axis and passing through this point E, as a function of the angular position of the point E of the internal volume V. In the same way, it is also observed that the law of variation of the relative orientation of the magnetic induction generated by the permanent magnet at a point E of the given circle is a periodic function presenting the same even integer Np greater than or equal to 2 of angular periods over the 360° of the internal volume V about of the main axis A′. The law of variation of the relative orientation of the magnetic induction Bm generated by the permanent magnet therefore has the same number Np of angular periods than the law of variation of the relative orientation of the magnetization vector in the magnetized body 10. Of course, these properties will be encountered more precisely in a median area (in the axial direction) of the internal volume V, at a certain distance of the two axial ends of the magnetized body, even more particularly in a median plane of the permanent magnet, that is to say a plane perpendicular to the axis of rotation which is equidistant from the axial ends of the magnetized body 10.

For a variation of φrp(θ(P)) close to the linear variation, for different points E of the internal volume V delimited by the magnetized body 10, located on the same radial segment coming from the main axis A′, the orientation, in orthogonal projection on a plane perpendicular to a plane perpendicular to the main axis A′, of the vector of the magnetic induction Bm induced by the magnetized body varies little as a function of the point. On the other hand, for different points E of the internal volume V delimited by the magnetized body 10, located on the same radial segment originating from the main axis A′, the magnitude of the vector of the magnetic induction Bm induced by the magnetized body varies as a function of the distance at which the considered point E is located with respect to the main axis A′. The magnetic induction is zero at the center of the magnet and its intensity increases as a function of the distance at which the considered point E is located with respect to the main axis A up to a maximum value close the inner surface of the magnet. This maximum value depends on the material and dimensions of the magnet.

Also, a sensor system 1 for determining a relative angular position Ω(t) of a first part 14 with respect to a second part 16 about an axis of rotation A will be advantageously designed as follows.

The sensor system 1 of course comprises a permanent magnet having a magnetized body 10 with the characteristics above. For the exemplary embodiments of FIGS. 8 to 12, the case of a permanent magnet having a law of variation of the relative orientation φrp(θ(P)) of the magnetization vector with 2 angular periods over the 360° of the magnetized body about its main axis A′ will be more particularly described. In all cases, it will be ensured that the permanent magnet is disposed such that the main axis A′ of the magnetized body 10 coincides with the axis of rotation A of the relative rotation between the first part 14 and the second part 16.

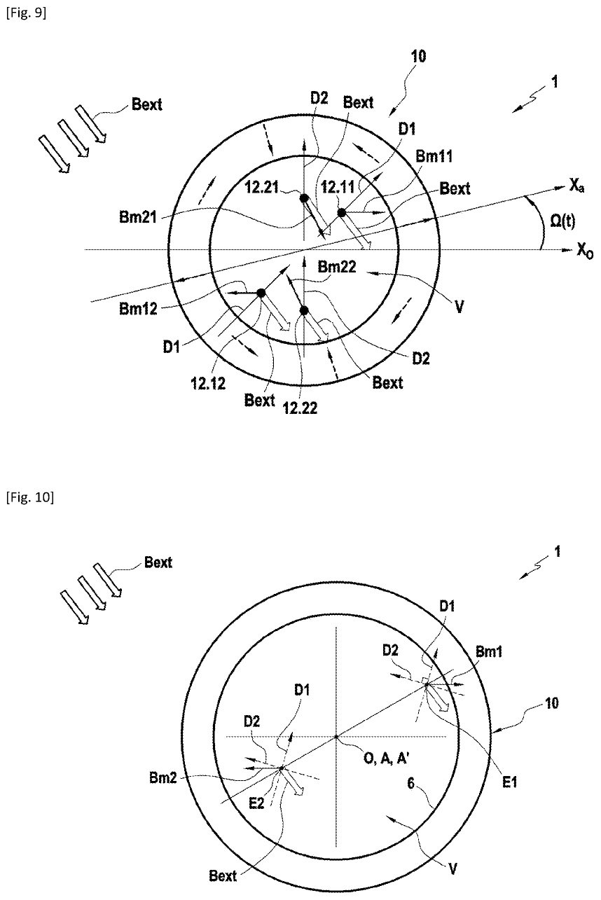

In this context, it was seen that the sensor system 1 includes a main set of 4 magnetic induction B measuring elements 12.11, 12.12, 12.21, 12.22 which will be disposed in the internal volume V delimited by the inner surface 6 of the magnetized body 10. Different positioning and orientation possibilities are possible for these measurement elements 12.11, 12.12, 12.21, 12.22. A general case of disposition is illustrated in FIG. 8 which therefore illustrates an embodiment of a sensor system 1. More particular embodiments are described in FIGS. 9 to 12.

In all cases, the sensor system 1 includes a primary pair of measurement elements 12.11, 12.12 comprising a first primary measurement element 12.11 and a second primary measurement element 12.12.

The first primary measurement element 12.11 is disposed at a first primary measurement point E11 fixed with respect to the second part 16. This first primary measurement element 12.11 makes it possible to determine, at this first primary measurement point E11, a first primary component B11 of the magnetic induction at this point E11, according to a primary measurement vector D1 perpendicular to the axis of rotation A.

The second primary measurement element 12.12 is disposed at a second primary measurement point E12 which is also fixed with respect to the second part 16. This second primary measurement element 12.12 makes it possible to determine, at this second primary measurement point E12, a second primary component B12 of the magnetic induction B according to the same primary measurement vector D1 as that of the first primary measurement element 12.11. It is noted that the second primary measurement element 12.12 makes it possible to determine, at this second primary measurement point E12, a second primary component B12 of the magnetic induction B according to the same primary measurement vector D1 as that of the first primary measurement element 12.11 even if it is mounted in the opposite direction with respect to the first primary measurement element 12.11. Indeed, in this case, the second primary measurement element 12.12 delivers a second raw primary component that only needs to be multiplied by the factor (−1) to obtain the second primary component B12 of the magnetic induction B according to the same primary measurement vector D1.

The first primary measurement point E11 and the second primary measurement point E12 are points distinct from each other on the same primary diametrical segment SD1 with respect to the axis of rotation A. These two points E11 and E12 are fixed with respect to the second piece 16, and fixed to each other. These two points E11 and E12 are located inside the internal volume V delimited by the magnetized body 10. It will be seen that there are preferential positions for these two points E11 and E12 on the primary diametrical segment SD1. Indeed, it will be advantageously provided that these two primary measurement points E11 and E12 are preferably symmetrical to each other with respect to the axis of rotation A. However, this condition is not mandatory. It is possible to have the two primary measurement points E11 and E12, disposed on either side of the axis of rotation A, but at different distances from the axis of rotation A, or disposed on the same side of the axis of rotation A, always at different distances therefrom.

In general, the primary measurement vector D1 forms, with respect to the primary diametrical segment SD1, a relative primary measurement angle μ1. Here again, this relative primary measurement angle μ1 can be arbitrary, but will be preferably equal to 0° or to 90°, so that the primary measurement vector D1 will in such a case be respectively parallel or perpendicular to the primary diametrical segment SD1.

Preferably, the primary measurement vector D1 is contained in a plane perpendicular to the axis of rotation A.

Furthermore, the two primary measurement elements each measure a primary component of the magnetic induction according to the same primary measurement vector D1. With such a disposition of the two primary measurement elements of the primary pair of measurement elements, and taking into account the symmetrical nature of the magnetic induction field Bm created by the permanent magnet in the internal volume V, it is ensured that the two elements of the same pair measure, according to the same measurement vector D1, the magnetic induction at two points at which the magnetic induction Bm created by the permanent magnet is vectorially different.

The sensor system 1 also includes a secondary pair of measurement elements 12.21, 12.22, comprising a first secondary measurement element 12.21 and a second secondary measurement point 12.22.

The first secondary measurement element 12.21 is disposed at a first secondary measurement point E21 fixed with respect to the second part 16. This first secondary measurement element 12.21 makes it possible to determine, at this first secondary measurement point E21, a first secondary component B21 of the magnetic induction B, according to a secondary measurement vector D2 perpendicular to the axis of rotation A.

The second secondary measurement element 12.22 is disposed at a second secondary measurement point E22 which is also fixed with respect to the second part 16. The second secondary measurement element 12.22 makes it possible to determine, at this second secondary measurement point, a second secondary component B22 of the magnetic induction B, according to the same secondary measurement vector D2 as that of the first secondary measurement element 12.21. As seen above for the primary measurement pair, the second secondary measurement element 12.22 makes it possible to determine, at this second secondary measurement point E22, a second secondary component B22 of the magnetic induction B according to the same secondary measurement vector D2 than that of the first secondary measurement element 12.21 even if it is mounted in the opposite direction with respect to the first secondary measurement element 12.21. Indeed, in this case, the second secondary measurement element 12.22 delivers a second raw secondary component that only needs to be multiplied by the factor (−1) to obtain the second secondary component B22 of the magnetic induction B according to the same secondary measurement vector D2.

The first secondary measurement point E21 and the second secondary measurement point E22 are points distinct from each other on the same secondary diametrical segment SD2 with respect to the axis of rotation A. These two points E21 and E22 are fixed with respect to the second part 16, and fixed to each other. These two points E21 and E2 are located inside the internal volume V delimited by the magnetized body 10. Just as for the primary measurement points E11 and E12, it will be seen that there are preferential positions for these two secondary measurement points E21 and E22 on the secondary diametrical segment SD2. Indeed, it can be advantageously provided that these two secondary measurement points E21 and E22 are preferably symmetrical to each other with respect to the axis of rotation A. However, this condition is not mandatory. It is thus possible to have the two secondary measurement points E21 and E22, disposed on either side of the axis of rotation, but at different distances from the axis of rotation A, or disposed on the same side of the axis of rotation A, always at different distances therefrom.

In general, the secondary measurement vector D2 forms, with respect to the secondary diametrical segment SD2, a relative secondary measurement angle μ2. Here again, this relative secondary measurement angle μ2 can be arbitrary, but will be preferably equal to 0° or to 90°, so that the secondary measurement vector D2 will in such a case be respectively parallel or perpendicular to the secondary diametrical segment SD2.

Each measurement element includes at least one magneto-sensitive component, for example Hall effect component, which delivers at least one electrical, for example digital and/or analog, signal representative of the corresponding component of the vector representative of the magnetic induction B at the measurement point of the considered measurement element, with respect to the measurement vector of this sensitive element. This component can be positive or negative depending on whether the vector representative of the magnetic induction B, at the measurement point of the considered measurement element is, in projection on the measurement vector, of the same direction as the measurement vector of this sensitive element, or in the opposite direction.

By way of example, it is possible to use a component from the MLX90372-Triaxis® Position Processor family marketed by the company Melexis NV, Rozendaalstraat 12, B-8900 leper, Belgium, in particular a component from the subfamily “Angular Rotary Strayfield Immune”, as described in the document “MLX90372—Triaxis® Position Processor Datasheet—REVISION 8-8 Mar. 2019”.

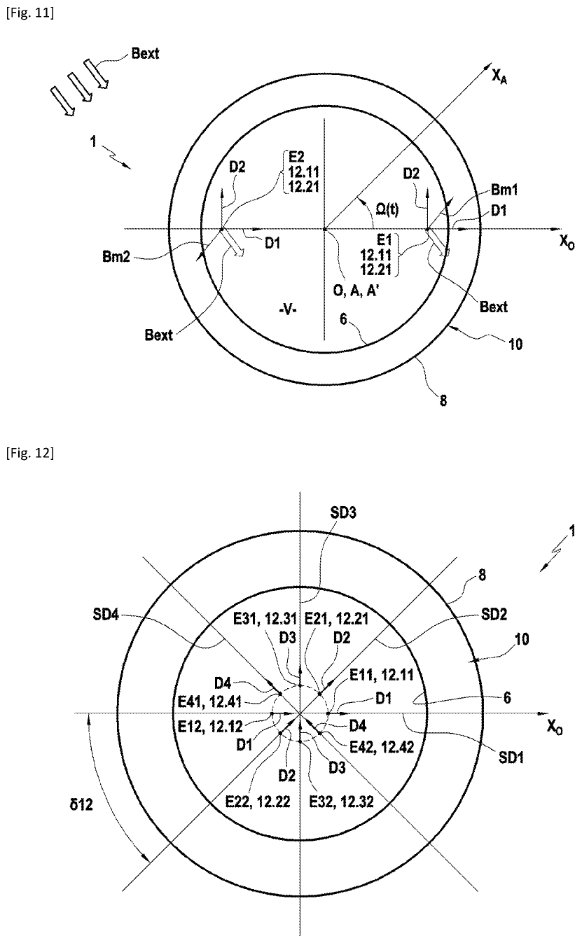

The different particular embodiments of the invention which are illustrated in the figures can be separated into two main families. In a first family of embodiments, such as those of FIGS. 8, 9 and 12, the primary diametrical segment SD1 and the secondary diametrical segment SD2 are distinct and it is then possible to determine an angular deviation 012 between the two about the axis of rotation A. In a second family of embodiments, such as those of FIGS. 10 and 11, the primary diametrical segment SD1 and the secondary diametrical segment SD2 are coincident, such that the four measurement elements are all four located on the same diametrical segment with respect to the axis of rotation. In this case, it is possible to consider that the angular deviation 012 between the primary diametrical segment SD1 and the secondary diametrical segment SD2 is zero. In a given reference frame, the angular deviation 012 between the primary diametrical segment SD1 and the secondary diametrical segment SD2 is equal to the angular position of the secondary diametrical segment SD2 from which the angular position of the primary diametrical segment SD1 is subtracted.

In general, the sensor system 1 is advantageously arranged so that the sum [(μ2−μ1)+Np×δ12] of, on the one hand, the angular deviation (μ2−μ1) between the relative secondary measurement angle μ2 and the relative primary measurement angle μ1 with, on the other hand, the angular deviation δ12, multiplied by the number Np of periods of the law of variation of the relative orientation φrp(θ(P)) of the magnetization vector as a function of the angular position of the point of the magnetized body, between the secondary diametrical segment SD2 and the primary diametrical segment SD1, is non-zero and different from a multiple of 180°.

This condition makes it possible to obtain two primary component measurements, i.e. two measurements according to the primary measurement vector, and two secondary component measurements, i.e. two measurements according to the secondary measurement vector, under conditions such that the measurements of the primary component are linearly independent of the measurements of the secondary component, or can be projected onto orthogonal vectors so as to give projected primary components which are linearly independent of projected secondary components.

Preferably, and as it is in particular the case with the embodiments of FIGS. 9, 10, 11 and 12, the sensor system is arranged so that the sum [(μ2−μ1)+Np×δ12] of, on the one hand, the angular deviation (μ2−μ1) between the relative secondary measurement angle μ2 and the relative primary measurement angle μ1 with, on the other hand, the angular deviation δ12, multiplied by the number of periods of the law of variation of the relative orientation φrp(θ(P)) of the magnetization vector as a function of the angular position of the point of the magnetized body, between the secondary diametrical segment SD2 and the primary diametrical segment SD1 is equal, modulo 360 degrees, to 90 degrees or to 270 degrees.

This condition makes it possible on the one hand to be able to determine two primary component measurements, i.e. two measurements according to the primary measurement vector, and two secondary component measurements, i.e. two measurements according to the secondary measurement vector, under conditions such that the measurements of the primary component are linearly independent of the measurements of the secondary component, which facilitates the calculation of the angle of the magnetic induction. There is then reference to measurements phase-shifted by 90 degrees in the magnetic field.

In the absence of this last condition, it will be necessary, in an intermediate step, to project the two primary component measurements and the two secondary component measurements on the same pair of orthogonal vectors so as to obtain projected primary components and projected secondary components on these two orthogonal vectors, with the two projected primary components thus obtained which are linearly independent of projected secondary components.

In some embodiments belonging to the first family of embodiments, such as the one illustrated in FIG. 9 or the one illustrated in FIG. 12, the sensor system 1 is arranged so that the relative secondary measurement angle μ2 and the relative primary measurement angle μ1 are equal, and such that the angular deviation δ12 between the secondary diametrical segment SD2 and the primary diametrical segment SD1 is a quarter of an angular period T/4 of the law of variation of the relative orientation φrp(θ(P)) of the magnetization vector, modulo the half angular period T/2 of the law of variation of the relative orientation φrp(θ(P)) of the magnetization vector. This configuration also makes it possible to obtain measurements phase-shifted by 90 degrees in the magnetic domain, as mentioned above.

In the particular example of FIG. 9 or the one illustrated in FIG. 12, the fact that the relative secondary measurement angle μ2 and the relative primary measurement angle μ1 are equal is reflected by the fact that the primary measurement vector D1 and the secondary measurement vector D2 are both oriented in radial directions with respect to their respective measurement point. Thus, the primary measurement vector D1 is oriented in a radial direction, with respect to the axis of rotation A, which passes through the first primary measurement point E11 and through the second primary measurement point E12, and the secondary measurement vector D2 is oriented in a radial direction, with respect to the axis of rotation A, which passes through the first secondary measurement point E21 and through the second secondary measurement point E22. It will be noted that, insofar as the secondary diametrical segment SD2 and the primary diametrical segment SD1 are not coincident, the fact that the relative secondary measurement angle μ2 and the relative primary measurement angle μ1 are equal necessarily implies that the primary measurement vector D1 and the secondary measurement vector D2 are distinct in a fixed reference frame linked to the second part 16.

It is noted that, in particular variants of the embodiments of FIGS. 9 and 12, the fact that the relative secondary measurement angle μ2 and the relative primary measurement angle μ1 are equal could be reflected by the fact that the primary measurement vector D1 and the secondary measurement vector D2 are both oriented in tangential directions relative to the axis of rotation A with respect to their respective measurement point.

In the specific examples of FIGS. 9 and 12, the angular deviation 012 between the secondary diametrical segment SD2 and the primary diametrical segment SD1 is a quarter of an angular period T/4 of the law of variation of the relative orientation φrp (θ(P)) of the magnetization vector. However, this angular deviation δ12 could be ¾, 5/4 or 7/4 of the angular period, regardless of the even integer Np of angular period of the law of variation of the relative orientation φrp(θ(P)) of the magnetization vector over 360° about the main axis of the magnetized body 10. In cases where the law of variation of the relative orientation φrp(θ(P)) of the magnetization vector includes 4 or more angular periods about the main axis of the magnetized body 10, the angular deviation δ12 could be 9/4, 11/4; etc. . . . of the angular period.

In some embodiments belonging to the second family of embodiments, such as those illustrated in FIG. 10 and FIG. 11, the sensor system 1 is arranged so that the primary diametrical segment SD1 and the secondary diametrical segment SD2 are coincident and so that the primary measurement vector D1 and the secondary measurement vector D2 are orthogonal to each other. This configuration also makes it possible to obtain measurements phase-shifted by 90 degrees in the magnetic field, as mentioned above.

In this second family of embodiments, and as illustrated in the examples of FIG. 10 and of FIG. 11, it may be advantageously provided that the first primary measurement point and the first secondary point are coincident at the same point E1. Alternatively, or in combination, as illustrated in the examples of FIG. 10 and of FIG. 11, the second primary point and the second secondary point are coincident at the same point E2. In other words, in this second family of embodiments, the first primary measurement element 12.11 and the first secondary measurement element 12.21 can be arranged at the same point, and/or the second primary measurement element 12.12 and the second secondary measurement element 12.22 can be arranged at the same point. In such a case, the two measurement elements which are arranged at the same point, or arranged very close to each other, can be combined in the same measurement cell. The notion of measurement at a single point is assessed according to the spatial resolution of the position measurement delivered by the sensor. For example, two measurement elements could be considered at the same point if their respective measurement points are distant by less than 0.25 millimeter.

In all the configurations having the characteristics given above, the four measurement elements 12.11, 12.12, 12.21, 12.22 therefore each deliver a value of a component of the magnetic induction B11, B12, B21, B22 at a measurement point. With the characteristics given above, each component of the magnetic induction B11, B12, B21, B22 which is thus measured differs from the three others, taken one by one, either by the point at which it is measured or by the measurement vector according to which the component is measured.

In some embodiments, such as those of FIGS. 9, 11 and 12, the first primary measurement point E11, E1 and the second primary measurement point E21, E2 are arranged at the same distance on each side of the axis of rotation A. In addition or alternatively, in some embodiments, such as those of FIGS. 9, 11 and 12, the first secondary measurement point E21, E1 and the second secondary measurement point E22, E2 are also arranged at the same distance on each side of the axis of rotation. In both cases, this allows the two measurement elements of the same pair to measure the magnetic induction created by the permanent magnet at two points where the respective vectors of the magnetic induction are opposite each other but have the same magnitude. This makes the best use of the fact that the magnetized body 10 has a geometry and a magnetization which are symmetrical with respect to the main axis A′, therefore with respect to the axis of rotation A if the positioning uncertainties are neglected, so that the field of the magnetic induction Bm created by the magnet in the internal volume V delimited by the magnetized body 10 is also symmetrical with respect to the main axis A′, therefore with respect to the axis of rotation A.

In the embodiments of FIGS. 9, 11 and 12, the first primary measurement point and the second primary measurement point are arranged at the same first distance from the axis of rotation, and the first secondary measurement point and the second secondary measurement point are arranged at the same first distance from the axis of rotation. In other words, the four measurement elements are all at the same distance from the axis of rotation A. In these exemplary embodiments, this allows the four measurement elements to measure the magnetic induction Bm created by the permanent magnet at points where the respective vectors of the magnetic induction Bm have the same magnitude.

In some embodiments, it will be sought to dispose each magnetic induction measuring element as close as possible to the inner surface 6 of the magnetized body 10. This indeed makes it possible, by limiting the distance called “air gap” distance, to benefit, at the measurement point of the measurement element, from an intensity of the magnetic induction Bm created by the magnet which will be maximum.

However, it is noted that the magnetization of the magnetized body 10 is such that, as seen above, levels of intensity of the magnetic induction Bm created by the magnetized body which are significant for a given value of the intensity of the magnetization vector M(P) in the magnetized body 10, are obtained in the internal volume V. This can be utilized to implement a less bulky magnetized body or made of less efficient and less expensive magnetic material, and/or to allow a distance called “air gap” distance greater than the one usually implemented. It will be seen that this last possibility can be more particularly utilized, as in the example of FIG. 12.

Typically, the distance called “air gap” distance will be preferably comprised between 0.5 and 8 millimeters.

It was seen that the measurement elements are arranged in the internal volume V delimited by the inner surface 6 of the magnetized body. This contributes to good compactness of the sensor system, in particular in the axial direction of the axis of rotation A. This also contributes to good robustness of the angular position determination delivered by the sensor system, with respect to possible inaccuracies as to the relative position of the magnetized body and of the measurement elements of the sensor system in the axial direction of the axis of rotation of the sensor system.

Preferably, the two measurement points E11, E21, E1, E2 of the primary pair of measurement elements 12.11, 12.21 and/or the two measurement points E21, E22, E1, E2 of the secondary pair of measurement elements 12.21, 12.22 are arranged in the same plane perpendicular to the axis of rotation A. This makes it possible to limit the influence of any inhomogeneity, in the axial direction, of the magnetic induction field Bm created by the magnet in the internal volume V delimited by the magnetized body 10. Preferably, this same plane perpendicular to the axis of rotation is equidistant from the axial ends of the magnetized body 10, in order to limit the influence of the inevitable edge effects at the level of the axial ends of the magnetized body 10. This further enhances the robustness of the angular position determination delivered by the sensor system, with respect to possible inaccuracies as to the relative position of the magnetized body and of the measurement elements of the sensor system in the axial direction of the axis of rotation of the sensor system.

In the particular example of FIG. 12, there is the same arrangement as the arrangement of FIG. 9, but by multiplying the measurement points. The particular example of FIG. 12 first has a main set of 4 magnetic induction B measuring elements 12.11, 12.12, 12.21, 12.22 having the same characteristics than those described for that of FIG. 9 but, in one of the possible variants, it could have been possible to start with a main set of 4 measurement elements having the same characteristics as those described for that of FIG. 11.

The embodiment of FIG. 12 is an example in which there is, in addition to the main set of 4 magnetic induction B measuring elements 12.11, 12.12, 12.21, 12.22, an additional set of 4 elements of additional measurements 12.31, 12.32, 12.41, 12.42 of the magnetic induction B, which are disposed in the internal volume V delimited by the inner surface 6 of the magnetized body 10. This additional set includes a tertiary pair of measurement elements 12.31, 12.32 comprising a first tertiary measurement element 12.31 and a second tertiary measurement element 12.32, respectively disposed at a first tertiary measurement point E31 fixed with respect to the second part 16 to determine a first tertiary component B31 of the magnetic induction at this point E31, according to a tertiary measurement vector D3 perpendicular to the axis of rotation A, and at a second tertiary measurement point E32 fixed with respect to the second part 16 to determine, at this second tertiary measurement point E32, a second tertiary component B32 of the magnetic induction B according to the same tertiary measurement vector D3 as that of the first tertiary measurement element 12.31. The first tertiary measurement point E31 and the second tertiary measurement point E32 are points distinct from each other on the same tertiary diametrical segment SD3 with respect to the axis of rotation A. Furthermore, the two tertiary measurement elements each measure a tertiary component of the magnetic induction according to the same tertiary measurement vector D3.

The additional set also includes a quaternary pair of measurement elements 12.41, 12.42, comprising a first quaternary measurement element 12.41 and a second quaternary measurement point 12.42 disposed respectively at a first quaternary measurement point E41 fixed with respect to the second part 16 to determine, at this first quaternary measurement point E41, a first quaternary component B41 of the magnetic induction B, according to a quaternary measurement vector D4 perpendicular to the axis of rotation A, and at a second quaternary measurement point E42 which is also fixed with respect to the second part 16 to determine, at this second quaternary measurement point, a second quaternary component B42 of the magnetic induction B, according to the same quaternary measurement vector D4 as that of the first quaternary measurement element 12.41. The first quaternary measurement point E41 and the second quaternary measurement point E42 are points distinct from each other on the same quaternary diametrical segment SD4 with respect to the axis of rotation A.

For this additional set, either of the variants which have been described or which will be described with reference to the main set of 4 measurement elements can be provided.

The main set of 4 measurement elements and the additional set are distinct sets in the sense that a measurement element of the additional set is arranged at a distinct point with respect to any measurement element of the main set or determines, at its measurement point, a component of the magnetic induction B according to a vector not parallel to the measurement vector of any other measurement element that would be arranged at the same point. Preferably, the tertiary diametrical segment SD3 and the quaternary diametrical segment SD4 are each distinct both from the primary diametrical segment SD1 and from the secondary diametrical segment SD2.

The presence of an additional set of 4 additional magnetic induction measuring elements 12.31, 12.32, 12.41, 12.42 can be utilized to implement redundancy of the measurement and/or, as will be explained below, to increase the measured magnetic induction intensity, in order to increase the signal/noise ratio of the sensor,

In the example of FIG. 12, the tertiary diametrical segment SD3 and the quaternary diametrical segment SD4 are each angularly offset respectively from the primary diametrical segment SD1 and from the secondary diametrical segment SD2. In some variants not illustrated, this angle could be arbitrary. However, for the example of FIG. 12, it is chosen to illustrate the case of an angle which is equal to an angular half-period T of the law of variation of the relative orientation φrp(θ(P)) of the magnetization vector as a function of the angular position of the point of the magnetized body, for the magnetized body implemented in the sensor system. Thus, with a magnetized body 10 having 2 angular periods T over the 360° of the magnetized body 10 about the main axis A′, the tertiary diametrical segment SD3 and the quaternary diametrical segment SD4 are each angularly offset by 90° respectively from the primary diametrical segment SD1 and the secondary diametrical segment SD2. As moreover the angular deviation δ12 between the secondary diametrical segment SD2 and the primary diametrical segment SD1 is a quarter of an angular period T/4 of the law of variation of the relative orientation φrp(θ(P)) of the magnetization vector, so here of 45 degrees, the four primary SD1, secondary SD2, tertiary SD3 and quaternary SD4 diametrical segments are disposed, in this order, at 45 degrees of angle from each other about the axis of rotation A.

In general, the tertiary measurement vector D3 forms, with respect to the tertiary diametrical segment SD3, a relative primary measurement angle which can be arbitrary, but which will be preferably equal to 0° or to 90°, so that the tertiary measurement vector D3 will in such a case be respectively parallel or perpendicular to the tertiary diametrical segment SD3. Preferably, the tertiary measurement vector D3 is contained in a plane perpendicular to the axis of rotation A.

In general, the quaternary measurement vector D4 forms, with respect to the quaternary diametrical segment SD4, a relative quaternary measurement angle which can be arbitrary, but which will be preferably equal to 0° or 90°, so that the quaternary measurement vector D4 will in such a case be respectively parallel or perpendicular to the quaternary diametrical segment SD4.

In the example of FIG. 12, all the measurement vectors D1, D2, D3, D4 form, with respect to the quaternary diametrical segment SD4, the same relative measurement angle. In this case, all the measurement vectors D1, D2, D3, D4 are oriented in radial directions with respect to their respective measurement point.

In the example of FIG. 12, it is noted that, on the one hand, the relative primary measurement angle and the relative tertiary measurement angle are equal, and on the other hand the tertiary diametrical segment SD3 and the primary diametrical segment SD1 are offset by an angle which is equal to an angular half-period T. From this combination, and also by taking into account the periodic nature of the magnetic induction Bm created by the magnetized body 10, it follows that the first tertiary component B31 and the first primary component B11 are components which vary in phase opposition with each other as a function of the relative rotation between the magnetized body and the measurement elements. In this way, the first tertiary component B31 and the first primary component B11 are not linearly independent. There is the same phase opposition for the variations of the second tertiary component B32 and the second primary component B12. Likewise, the relative secondary measurement angle and the relative quaternary measurement angle are equal, and the quaternary diametrical segment SD4 and the secondary diametrical segment SD2 are offset by an angle which is equal to an angular half-period T, so that the first quaternary component B41 and the first secondary component B21 are components that vary in phase opposition with each other the other as a function of the relative rotation between the magnetized body and the measurement elements. There is the same phase opposition for the variations of the second quaternary component B42 and the second secondary component B22. Therefore, it will be seen that the measurements made with the additional set of 4 additional measurement elements can be combined with those made with the main set to increase the measured magnetic induction intensity, this in order to increase the signal/noise ratio of the sensor.

Furthermore, in the example of FIG. 12, all the measurement points are arranged at the same first distance from the axis of rotation A. It is noted that, in this embodiment, the measurement points are arranged closer to the axis of rotation A than to the inner surface 6 of the magnetized body 10. All the measurement points can thus be arranged within a circle centered on the axis of rotation whose radius can be less than half, or even less than a quarter of the internal radius “ri” of the inner surface 6 of the magnetized body 10. This arrangement makes it possible to combine all the measurement elements on the same component, to the advantage of the cost, the space requirement and the ease of production of the sensor system 1.

To exploit these magnetic induction measurements made by the measurement elements, the sensor system comprises an electronic calculation unit 100 programmed to calculate a value representative of the relative angular position Ω(t) of the first part 14 with respect to the second part 16.

The electronic calculation unit 100 can be integrated into the sensor system 1, or be remote from the sensor system 1, for example in an electronic control unit or a computer. The electronic calculation unit 100 typically includes one or more memory modules, at least a processor, a data input/output module, and possibly a communication module. In such an electronic calculation unit 100, the calculation steps of a method are typically implemented by a computer program containing the corresponding instructions and stored in the memory module. Very often, one or more measurement elements and the electronic calculation unit form part of the same electronic component, which makes it possible to reduce the cost and increase the reliability of the sensor system 1. It can be envisaged to provide that the four or more measurement elements 12.11, 12.12, 12.21, 12.22 are integrated into the same electronic component, which can comprise an electronic calculation unit 100 common to the four measurement elements. However, in the context of the invention, it can be provided that the four or more measurement elements are provided with a communication unit for communicating information to a remote electronic calculation unit, for example hosted in an electronic control unit (ECU) or a computer.

The electronic calculation unit 100 is therefore programmed to implement a method for determining the relative angular position ((t) of the first part 14 with respect to a second part 16 over an angular stroke about the axis of rotation A.

This method is based on the fact that the first part 14 is equipped with a permanent magnet as described above, which therefore generates, in the internal volume V delimited by the inner surface 6 of the magnetized body 10, a magnetic induction field Bm having the characteristics above.

In this method, a first primary component B11 of the magnetic induction B is determined at a first primary measurement point E11, E1 according to a primary measurement vector D1 perpendicular to the axis of rotation A, and a second primary component B12 of the magnetic induction is determined at a second primary measurement point E12, E2 according to the same primary measurement vector D1. As indicated above, the first primary measurement point E11, E1 and the second primary measurement point E12, E2 are points distinct from each other on the same primary diametrical segment SD1 with respect to the axis of rotation A, and they are located inside the internal volume V delimited by the magnetized body 10. The primary measurement vector D1 forms, with respect to the primary diametrical segment SD1, a relative primary measurement angle μ1.

Similarly, a first secondary component B21 of the magnetic induction B is determined at a first secondary measurement point E21, E1 according to a secondary measurement vector D2 perpendicular to the axis of rotation A, and a second secondary component B22 of the magnetic induction B is determined at a second secondary measurement point E22, E2 according to the same secondary measurement vector D2, the first secondary measurement point and the second secondary measurement point being points distinct from each other on the same secondary diametrical segment SD2 with respect to the axis of rotation A and being located inside the internal volume V delimited by the magnetized body 10, and the secondary measurement vector D2 forming, with respect to the secondary diametrical segment SD2, a relative secondary measurement angle μ2.

In the method, it is provided that the sum [(μ2−μ1)+Np×δ12] of, on the one hand, the angular deviation (μ2−μ1) between the relative secondary measurement angle μ2 and the relative primary measurement angle μ1 with, on the other hand, the angular deviation δ12, multiplied by the number Np of periods (T) of the law of variation of the relative orientation φrp(θ(P)) of the magnetization vector M(P) as a function of the angular position θ(P) of the point P of the magnetized body (10), between the secondary diametrical segment SD2 and the primary diametrical segment SD2, is non-zero and different from a multiple of 180°.

In this way, in the method, a value representative of the relative angular position Ω(t) of the first part 14 with respect to the second part 16 is calculated, based on a calculation comprising on the one hand, a difference (B12−B11) or (B11−B12) between the two primary components and, on the other hand, a difference (B22−B21) or (B21−B22) between the two secondary components.

A representative value of the relative angular position Ω(t) of the first part 14 with respect to the second part 16 can be calculated based on the calculation of the arc-tangent of a ratio between, on the one hand, a difference (B12−B11) between the two primary components and, on the other hand, a difference (B22−B21) between the two secondary components, ratio in which each difference of components is weighted as a function of the distance, for the considered difference, between the corresponding measurement points and the axis of rotation A.

It is noted that, if the measurements are made in such a way that the measurements are not phase-shifted by 90 degrees in the magnetic field between the primary components and the secondary components, a projection of the two primary component measurements and of the two secondary component measurements on the same pair of orthogonal vectors is conducted in an intermediate step, so as to obtain projected primary components and projected secondary components on these two orthogonal vectors, with the two projected primary components thus obtained which are linearly independent of projected secondary components.

Thus, in one example, it is provided to calculate a value ΔB1 representative of the difference between the first primary component B11 and the second primary component B12. This value can be considered as a primary differential component, according to the primary measurement vector. Typically this difference value can be written in the form of a function:

ΔB1=f1(B11−B12)

for example a linear or affine function:

ΔB1=a1×(B11−B12)+k1

In a simple case, we can have:

ΔB1=B11−B12 (1)

Similarly, it is provided to calculate a value ΔB2 representative of the difference between the first secondary component B21 and the second secondary component B22. This value can be considered as a secondary differential component, according to the secondary measurement vector. Typically, this difference value can be written in the form of a function,

ΔB2=f2(B21−B22)

for example a linear or affine function:

ΔB2=a2×(B21−B22)+k2

In a simple case, we can have:

ΔB2=B21−B22 (2)

In the general equations above, the coefficients a1, k1 on the one hand, and a2, k2 on the other hand are corrective coefficients which may be determined by calculation or by calibration.

The coefficients a1, a2, k1 and k2 are coefficients whose main role is to weight the values measured for B11, B12, B21 and B22 according to the differences between, on the one hand, the respective average position of the first primary point E11 and of the second primary point E12 with respect to the axis of rotation A, and on the other hand the respective average position of the first secondary point E12 and of the second secondary point E22 with respect to the axis of rotation A. This is how the differences ΔB1 and ΔB2 are weighted as a function of the distance, for the considered difference, between the corresponding measurement points and the axis of rotation A. If the pairs of points are at the same average distance from the axis of rotation, then the coefficients a1 and a2 may be equal or substantially equal to each other, or even equal or substantially equal to 1. However, even in this case, the coefficients a1, a2, k1 and k2 could be used to weight the values measured for B11, B12, B21 and B22 as a function, in addition or alternatively, for example, of the present geometric defects, such as eccentricity or misalignment of the measurement axes, or of the respective sensitivity of the different measurement elements. The coefficients a1, a2, k1 and k2 will be for example chosen so that, over a complete angular period T of the law of variation of the relative orientation φrp(θ(P)) of the magnetization vector, the quantities ΔB1 and ΔB2 as a function of the angle of mechanical rotation have the same amplitude and a zero average value.

If an additional set of 4 additional measurement elements 12.31, 12.32, 12.41, 12.42 is implemented, as described in relation to the example of FIG. 12, it is possible to use, as representative values of the difference between the first primary component and the second primary component, a difference value in the form of:

ΔB1=a1×(B11−B12)−a′1(B31−B32)+k1

which, in a simplified form can become, in particular with measurement points at the same distance from the axis of rotation:

ΔB1=(B11−B12)−(B31−B32)

and, as values representative of the difference between the first secondary component and the second secondary component, a difference value in the form of:

ΔB2=a2×(B21−B22)−a′2(B41−B42)+k2

which, in a simplified form can become, in particular with measurement points at the same distance from the axis of rotation:

ΔB2=(B21−B22)−(B41−B42)

A value representative of the relative angular position Ω(t) of the first part 14 with respect to the second part 16 can be calculated in the form of a raw angle β, this raw angle β being the arc whose tangent is representative of the ratio mentioned above between, on the one hand, a difference between the two primary components and, on the other hand, a difference between the two secondary components. In this ratio, each difference is weighted as a function, for the considered difference, of the distance between the corresponding measurement points and the axis of rotation. Depending on the chosen ratio, we will get the raw angle β or its complement (90°-β), from which we easily return to the desired raw angle.

Thus, this raw angle value ß can be written in the form of a function:

β=Arctan{F[ΔB1/ΔB2]}ouβ=Arctan{F[ΔB2/ΔB1]}

In this equation, the function F can be considered as a correction function of the measured values.

In a simple case, we can have:

β=Arctan{K12×[ΔB1/ΔB2]} (3)

where K12 is a value to compensate for the difference in amplitude between the signals on the two measurement vectors, for example due to the position of the measurement elements.

The raw angle β is a function of the orientation of the magnetic induction field Bm created by the permanent magnet at each of the measurement points, or is representative thereof. By the fact that the magnetization of the magnetized body has a variable orientation as a function of the angular position over an angular period T, as explained above, the magnetic induction field created by the magnetized body, in the internal volume delimited by the magnetized body 10, also has a variable orientation over an angular period, which is also symmetrical. It is possible to determine a relation between the raw angle β and the relative angular position Ω(t) between the two parts 14, 16.

In the case of a linear variation of φrp(θ(P)), the relation between relative angular position Ω(t) is obtained from the raw angle β and the number of periods Np of φrp(θ(P)) by the following relation:

Ω(t)=β/Np

In the case of a non-linear variation, this relation can be determined for example by calculation, by simulation or by learning.

Above all, it will be shown that the raw angle thus calculated is independent of the presence or absence of an external magnetic field Bext which would be superimposed, even in the internal volume V delimited by the magnetized body 10, on the magnetic induction Bm created by the permanent magnet. Generally, this external magnetic field Bext will be imposed by elements relatively far from the measurement elements, so that it will most often be possible to consider that this external magnetic field Bext is constant in direction and in intensity in the internal volume V delimited by the magnetized body 10.

In general, it was seen that the magnetic induction Bm created by the permanent magnet in the internal volume V delimited by the magnetized body 10 is symmetrical with respect to the axis of rotation A. In addition, it was seen that on a given radial segment in the internal volume V with respect to the main axis A′, the vector of the magnetic induction Bm created by the permanent magnet in the internal volume V delimited by the magnetized body 10 has a substantially constant orientation.

As a result, if only the magnetic induction Bm created by the permanent magnet is considered, when the difference between the two primary components is made, we necessarily have a value different from 0 since the two primary measurement points E11 and E12 are distinct. Better, due to the symmetrical nature of the magnetic induction Bm created by the permanent magnet, if the two primary measurement points E11 and E12 are arranged on either side of the axis of rotation A, therefore on either side of the main axis A′, then the two primary components measured at these two points have opposite signs. In this way, by making the difference between the two measured primary components, a sum of the absolute value of the two measured primary components is actually made.

If an external magnetic field Bext constant in direction and intensity is now considered, when the difference between the two primary components is made we will necessarily have a zero value or a value close to 0.

In this way, by considering the superposition B of the magnetic induction Bm created by the permanent magnet and of an external magnetic field Bext constant in direction and intensity, it is understood that the difference between the two primary components depends only on the magnetic induction Bm created by the permanent magnet.

The same goes for the two secondary components.

Thus, a sensor system 1 which is insensitive to the presence of an external magnetic field Bext constant in direction and intensity was created.

1. A sensor system for determining a relative angular position (Ω(t)) of a first part (14) with respect to a second part (16) about an axis of rotation (A), the system comprising:
a permanent magnet having a magnetized body (10) in the form of a tubular portion symmetrical about a main axis (A′) of the magnetized body, the permanent magnet being:
such that the magnetized body has a permanent magnetization such that, for any point of the magnetized body on a given circle about the main axis, each point (P) of the magnetized body on this given circle (Crp) having an angular position defined by the angle (θ(P)) formed, about the main axis (A′) and with respect to a fixed reference axis (Xa) of the permanent magnet, by a particular radial segment (SRP) originating from the main axis (A′) and passing through this point (P), the magnetization vector (M(P)) at a point (P) of the given circle (Crp) presents, in orthogonal projection on a plane perpendicular to the main axis (A′), a projected vector whose relative orientation (φrp(θ(P))) with respect to the particular radial segment (SRP) at this point (P) is a continuously variable function according to a law of variation of the relative orientation (φrp(θ(P))) as a function of the angular position (θ(P)) of the point (P) of the magnetized body (10),
such that the law of variation of the relative orientation (φrp(θ(P))) of the magnetization vector (M(P)) is a periodic function presenting an even integer (Np) greater than or equal to 2 of angular periods (T) over the 360° of the magnetized body (10) about the main axis (A′),
and such that the law of variation of the relative orientation (φrp(θ(P))) of the magnetization vector (M(P)) implies a positive variation of the relative orientation (φrp(θ(P))) of the projected vector, in orthogonal projection on a plane perpendicular to the main axis (A′), of the magnetization vector M(P) at a point (P), with respect to the particular radial segment (SRP), as a function of a positive variation of the angular position (θ(P)) of the point (P) of the magnetized body (10),
the permanent magnet being disposed such that the main axis (A′) of the magnetized body (10) coincides with the axis of rotation (A);
a primary pair of measurement elements comprising a first primary measurement element (12.11) making it possible to determine, at a first primary measurement point (E11), a first primary component (B11) of the magnetic induction according to a primary measurement vector (D1) perpendicular to the axis of rotation (A), and comprising a second primary measurement element (12.12) making it possible to determine, at a second primary measurement point (E12), a second primary component (B12) of the magnetic induction according to the same primary measurement vector (D1), the first primary measurement point (E11) and the second primary measurement point (E12) being points distinct from each other on the same primary diametrical segment (SD1) with respect to the axis of rotation (A) and being located inside the internal volume (V) delimited by the magnetized body (10), and the primary measurement vector (D1) forming, with respect to the primary diametrical segment (SD1), a relative primary measurement angle (μ1);
a secondary pair of measurement elements comprising a first secondary measurement element (12.21) making it possible to determine, at a first secondary measurement point (E21), a first secondary component (B21) of the magnetic induction according to a secondary measurement vector (D2) perpendicular to the axis of rotation (A), and comprising a second secondary measurement element (12.22) making it possible to determine, at a second secondary measurement point (E22), a second secondary component (B22) of the magnetic induction according to the same secondary measurement vector (D2), the first secondary measurement point (E21) and the second secondary measurement point (E22) being points distinct from each other on the same secondary diametrical segment (SD2) with respect to the axis of rotation (A) and being located inside the internal volume (V) delimited by the magnetized body (10), and the secondary measurement vector (D2) forming, with respect to the secondary diametrical segment (SD2), a relative secondary measurement angle (μ2);
the system being arranged so that the sum ((μ2−μ1)+Np×δ12) of, on the one hand, the angular deviation (μ2−μ1) between the relative secondary measurement angle (μ2) and the relative primary measurement angle (μ1) with, on the other hand, the angular deviation (δ12), multiplied by the number (Np) of periods of the law of variation of the relative orientation φrp(θ(P)) of the magnetization vector M(P) as a function of the angular position (θ(P)) of the point (P) of the magnetized body (10), between the secondary diametrical segment (SD2) and the primary diametrical segment (SD1), is non-zero and different from a multiple of 180 degrees;
and the sensor system (1) comprising an electronic calculation unit (100) programmed to calculate a value representative of the relative angular position (Ω(t)) of the first part (14) with respect to the second part (16), based on a calculation of the arc-tangent (β=Arctan {F[ΔB1/ΔB2]}; β=Arctan {F[ΔB2/ΔB1]}) of a ratio (ΔB2/ΔB1; ΔB1/ΔB2) between, on the one hand, a difference (ΔB1) between the two primary components (B11; B12) and, on the other hand, a difference (ΔB2) between the two secondary components (B21; B22), ratio in which each difference is weighted as a function of the distance, for the considered difference, between the corresponding measurement points and the axis of rotation.

2. The sensor system according to claim 1, characterized in that the sensor system is arranged so that the sum ((μ2−μ1)+Np×δ12) of, on the one hand, the deviation ((μ2−μ1)) between the relative secondary measurement angle (μ2) and the relative primary angle measurement angle (μ1) with, on the other hand, the angular deviation (δ12), multiplied by the number (Np) of periods (T) of the law of variation of the relative orientation (φrp(θ(P))) of the magnetization vector (M(P)) as a function of the angular position (θ(P)) of the point (P) of the magnetized body (10), between the secondary diametrical segment (SD2) and the primary diametrical segment (SD1) is equal, modulo 360 degrees, to 90 degrees or to 270 degrees.

3. The sensor system according to claim 1, characterized in that the sensor system (1) is arranged so that the relative secondary measurement angle (μ2) and the relative primary measurement angle (μ1) are equal, and in that the angular deviation (δ12) between the secondary diametrical segment (SD2) and the primary diametrical segment (SD1) is a quarter of an angular period (T) of the law of variation of the relative orientation (φrp(θ(P))) of the magnetization vector (M(P)), modulo the half angular period of the law of variation of the relative orientation (φrp(θ(P))) of the magnetization vector.

4. The sensor system according to claim 1, characterized in that the sensor system (1) is arranged so that the primary diametrical segment (SD1) and the secondary diametrical segment (SD2) are coincident and so that the primary measurement vector (D1) and the secondary measurement vector (D2) are orthogonal.

5. The sensor system according to claim 4, characterized in that the first primary measurement point (A11) and the first secondary measurement point (E21) are coincident.

6. The sensor system according to claim 4, characterized in that the second primary measurement point (E12) and the second secondary measurement point (E22) are coincident.

7. The sensor system according to claim 1, characterized in that the first primary measurement point (E11) and the second primary measurement point (E12) are arranged at the same distance on each side of the axis rotation (A).

8. The sensor system according to claim 1, characterized in that the first secondary measurement point (E21) and the second secondary measurement point (E22) are arranged at the same distance on each side of the axis of rotation (A).

9. The sensor system according to claim 1, characterized in that the first primary measurement point (E11) and the second primary measurement point (E12) are arranged at the same first distance from the axis of rotation (A), and in that the first secondary measurement point (E21) and the second secondary measurement point (E22) are arranged at the same first distance from the axis of rotation (A).

10. The sensor system according to claim 1, characterized in that the two measurement points of the primary pair and/or of the secondary pair of measurement elements are arranged in the same plane perpendicular to the axis of spin (A).

11. Sensor system according to claim 1, characterized in that the two measurement points of the primary pair and/or of the secondary pair of measurement elements are arranged in the same plane perpendicular to the axis of rotation (A) which is equidistant from the axial ends of the magnetized body (10).

12. The sensor system according to claim 1, characterized in that the magnetized body (10) has a planar magnetization such that, at any point (P) of the magnetized body (10), the magnetization vector (M(P)) at this point is parallel to a magnetization plane perpendicular to the main axis (A′).

13. The sensor system according to claim 1, characterized in that, on a given circle (Crp) about the main axis (A′), the law of variation of the relative orientation (φrp(θ(P))) of the magnetization vector M(P) is a bijective law over an angular period (T) of the law of variation of the relative orientation φrp(θ(P)) of the magnetization vector (M(P)).

14. The sensor system according to claim 1, characterized in that, on a given circle (Crp) about the main axis (A′), the law of variation of the relative orientation φrp(θ(P)) of the magnetization vector (M(P)) implies a 360° variation of the relative orientation (φrp(θ(P))) of the projected vector, in orthogonal projection on a plane perpendicular to the main axis, of the magnetization vector (M(P) at a point (P) of the given circle (Crp), for a variation of the angular position (θ(P)) of the point (P) of the magnetized body (10) corresponding to an angular period (T) of the law of variation of the relative orientation (φrp(θ(P))) of the magnetization vector (M(P)).

15. The sensor system according to claim 1, characterized in that, on a given circle (Crp) about the main axis (A′), the law of variation of the relative orientation (φrp(θ(P))) of the magnetization vector (M(P)) is a law of linear variation as a function of the angular position (θ(P)) of the point (P) of the magnetized body (10).

16. The sensor system according to claim 1, characterized in that the magnetized body (10) is a continuous body over 360° about the main axis (A′).

17. The sensor system according to claim 1, characterized in that the magnetized body is formed of elementary magnetized bodies juxtaposed over 360° about the main axis.

18. The sensor system according to claim 1, characterized in that the magnetized body (10) is a body in the form of a tubular portion of revolution about the main axis (A′).

19. The sensor system according to claim 1, characterized in that the magnetized body (10) is a body in the form of a cylindrical tubular portion about the main axis (A′).

20. A method for determining a relative angular position (Ω(t)) of a first part (14) with respect to a second part (16) on an angular stroke about an axis of rotation (A), characterized in that:
the first part is equipped with a permanent magnet having a magnetized body (10) in the form of a tubular portion symmetrical about a main axis (A′) of the magnetized body, the permanent magnet being:
such that the magnetized body has a permanent magnetization such that, for any point of the magnetized body on a given circle about the main axis, each point (P) of the magnetized body on this given circle (Crp) having an angular position defined by the angle (θ(P)) formed, about the main axis (A′) and with respect to a fixed reference axis (Xa) of the permanent magnet, by a particular radial segment (SRP) originating from the main axis (A′) and passing through this point (P), the magnetization vector (M(P)) at a point (P) of the given circle (Crp) presents, in orthogonal projection on a plane perpendicular to the main axis (A′), a projected vector whose relative orientation (φrp(θ(P))) with respect to the particular radial segment (SRP) at this point (P) is a continuously variable function according to a law of variation of the relative orientation (φrp(θ(P))) as a function of the angular position (θ(P)) of the point (P) of the magnetized body (10),
such that the law of variation of the relative orientation (φrp(θ(P))) of the magnetization vector (M(P)) is a periodic function presenting an even integer (Np) greater than or equal to 2 of angular periods (T) over the 360° of the magnetized body (10) about the main axis (A′),
and such that the law of variation of the relative orientation (φrp(θ(P))) of the magnetization vector (M(P)) implies a positive variation of the relative orientation (φrp(θ(P))) of the projected vector, in orthogonal projection on a plane perpendicular to the main axis (A′), of the magnetization vector M(P) at a point (P), with respect to the particular radial segment (SRP), as a function of a positive variation of the angular position (θ(P)) of the point (P) of the magnetized body (10);
determining, at a first primary measurement point (E11), a first primary component (B11) of the magnetic induction according to a primary measurement vector (D1) perpendicular to the axis of rotation (A) and, at a second primary measurement point (E12), a second primary component (B12) of the magnetic induction according to the same primary measurement vector (D1), the first primary measurement point (E11) and the second primary measurement point (E12) being points distinct from each other on the same primary diametrical segment (SD1) with respect to the axis of rotation (A) and being located inside the internal volume (V) delimited by the magnetized body (10), and the primary measurement vector (D1) forming, with respect to the primary diametrical segment (SD1), a relative primary measurement angle (μ1);
determining, at a first secondary measurement point (E21), a first secondary component (B21) of the magnetic induction, according to a secondary measurement vector (D2) perpendicular to the axis of rotation (A) and, at a second secondary measurement point (E22), a second secondary component (B22) of the magnetic induction according to the same secondary measurement vector (D2), the first secondary measurement point (E21) and the second secondary measurement point (E22) being points distinct from each other on the same secondary diametrical segment (SD2) with respect to the axis of rotation (A) and being located inside the internal volume (V) delimited by the magnetized body (10), and the secondary measurement vector (D2) forming, with respect to the secondary diametrical segment (SD2), a relative secondary measurement angle (μ2);
in that the sum ((μ2−μ1)+Np×δ12) of, on the one hand, the angular deviation (μ2−μ1) between the relative secondary measurement angle (μ2) and the relative primary angle measurement angle (μ1) with, on the other hand, the angular deviation (δ12), multiplied by the number (Np) of periods of the law of variation of the relative orientation φrp(θ(P)) of the magnetization vector (M(P)) as a function of the angular position (θ(P)) of the point (P) of the magnetized body (10), between the secondary diametrical segment (SD2) and the primary diametrical segment (SD1) is non-zero and different from a multiple of 180 degrees, and in that a value representative of the relative angular position (Ω(t)) of the first part (14) with respect to the second part (16) is calculated, based a calculation comprising, on the one hand, a difference (ΔB1) between the two primary components (B11, B12) and, on the other hand, a difference (ΔB2) between the two secondary components (B21; B22).

21. The determination method according to claim 20, characterized in that it comprises the calculation of the arc-tangent (β=Arctan {F[ΔB1/ΔB2]}; β=Arctan {F[ΔB2/ΔB1]}) of a ratio (ΔB2/ΔB1; ΔB1/Aβ2) between, on the one hand, the difference (ΔB1) between the two primary components and, on the other hand, the difference (ΔB2) between the two secondary components, ratio in which each difference is weighted as a function of the distance, for the considered difference, between the corresponding measurement points and the axis of rotation.

22. The determination method according to claim 20, characterized in that it is implemented with a sensor system comprising:
a permanent magnet having a magnetized body (10) in the form of a tubular portion symmetrical about a main axis (A′) of the magnetized body, the permanent magnet being:
such that the magnetized body has a permanent magnetization such that, for any point of the magnetized body on a given circle about the main axis, each point (P) of the magnetized body on this given circle (Crp) having an angular position defined by the angle (θ(P)) formed, about the main axis (A′) and with respect to a fixed reference axis (Xa) of the permanent magnet, by a particular radial segment (SRP) originating from the main axis (A′) and passing through this point (P), the magnetization vector (M(P)) at a point (P) of the given circle (Crp) presents, in orthogonal projection on a plane perpendicular to the main axis (A′), a projected vector whose relative orientation (φrp(θ(P))) with respect to the particular radial segment (SRP) at this point (P) is a continuously variable function according to a law of variation of the relative orientation (φrp(θ(P))) as a function of the angular position (θ(P)) of the point (P) of the magnetized body (10),
such that the law of variation of the relative orientation (φrp(θ(P))) of the magnetization vector (M(P)) is a periodic function presenting an even integer (Np) greater than or equal to 2 of angular periods (T) over the 360° of the magnetized body (10) about the main axis (A′),
and such that the law of variation of the relative orientation (φrp(θ(P))) of the magnetization vector (M(P)) implies a positive variation of the relative orientation (φrp(θ(P))) of the projected vector, in orthogonal projection on a plane perpendicular to the main axis (A′), of the magnetization vector M(P) at a point (P), with respect to the particular radial segment (SRP), as a function of a positive variation of the angular position (θ(P)) of the point (P) of the magnetized body (10),
the permanent magnet being disposed such that the main axis (A′) of the magnetized body (10) coincides with the axis of rotation (A);
a primary pair of measurement elements comprising a first primary measurement element (12.11) making it possible to determine, at a first primary measurement point (E11), a first primary component (B11) of the magnetic induction according to a primary measurement vector (D1) perpendicular to the axis of rotation (A), and comprising a second primary measurement element (12.12) making it possible to determine, at a second primary measurement point (E12), a second primary component (B12) of the magnetic induction according to the same primary measurement vector (D1), the first primary measurement point (E11) and the second primary measurement point (E12) being points distinct from each other on the same primary diametrical segment (SD1) with respect to the axis of rotation (A) and being located inside the internal volume (V) delimited by the magnetized body (10), and the primary measurement vector (D1) forming, with respect to the primary diametrical segment (SD1), a relative primary measurement angle (μ1);
a secondary pair of measurement elements comprising a first secondary measurement element (12.21) making it possible to determine, at a first secondary measurement point (E21), a first secondary component (B21) of the magnetic induction according to a secondary measurement vector (D2) perpendicular to the axis of rotation (A), and comprising a second secondary measurement element (12.22) making it possible to determine, at a second secondary measurement point (E22), a second secondary component (B22) of the magnetic induction according to the same secondary measurement vector (D2), the first secondary measurement point (E21) and the second secondary measurement point (E22) being points distinct from each other on the same secondary diametrical segment (SD2) with respect to the axis of rotation (A) and being located inside the internal volume (V) delimited by the magnetized body (10), and the secondary measurement vector (D2) forming, with respect to the secondary diametrical segment (SD2), a relative secondary measurement angle (μ2);
the system being arranged so that the sum ((μ2−μ1)+Np×δ12) of, on the one hand, the angular deviation (μ2−μ1) between the relative secondary measurement angle (μ2) and the relative primary measurement angle (μ1) with, on the other hand, the angular deviation (δ12), multiplied by the number (Np) of periods of the law of variation of the relative orientation φrp(θ(P)) of the magnetization vector M(P) as a function of the angular position (θ(P)) of the point (P) of the magnetized body (10), between the secondary diametrical segment (SD2) and the primary diametrical segment (SD1), is non-zero and different from a multiple of 180 degrees;
and the sensor system (1) comprising an electronic calculation unit (100) programmed to calculate a value representative of the relative angular position (δ(t)) of the first part (14) with respect to the second part (16), based on a calculation of the arc-tangent (β=Arctan {F[ΔB1/ΔB2]}; β=Arctan {F[ΔB2/ΔB1]}) of a ratio (ΔB2/ΔB1; ΔB1/ΔB2) between, on the one hand, a difference (ΔB1) between the two primary components (B11; B12) and, on the other hand, a difference (ΔB2) between the two secondary components (B21; B22), ratio in which each difference is weighted as a function of the distance, for the considered difference, between the corresponding measurement points and the axis of rotation.

23. A method for manufacturing a magnetized body for a system for determining a relative angular position (Ω(t)) of a first part (14) with respect to a second part (16) about an axis of rotation (A), the method comprising providing a body of magnetizable material (10) having a form of a tubular portion symmetrical about a major axis (A′) of the body of magnetizable material, the body of magnetizable material (10) thus having an inner surface (6) and a length in the direction of the main axis (A′);
characterized in that the method includes:
the disposition, in the internal volume (V) delimited by the body of magnetizable material (10), radially in the vicinity of the inner surface (6) of the body of magnetizable material and facing the body of magnetizable material over the length of the body of material magnetizable, of a pattern (20) of parallel electrical conductors (22) comprising a number of bundles (24) of parallel electrical conductors (22), the number of bundles (24) of parallel electrical conductors (22) being a non-zero multiple of 4, each electrical conductor (22) having an orientation parallel to the main axis (A′) and extending, in the direction of the main axis (A′), over a length at least equal to the length of the body of magnetizable material (10), and each bundle (24) being comprised in a distinct angular sector about the main axis (A′), the measurement of the angular sector of each bundle (24) being equal to 360 degrees of angle divided by the number of bundles (24), the bundles (24) being angularly offset from each other about the main axis (A);
the flow of an electric current in the bundles (24) of parallel electrical conductors (22), the direction of flow of the current, defined in a fixed reference frame with respect to the body of magnetizable material (10), being identical in all the parallel electrical conductors (22) of the same bundle (24), and being inverse in two angularly adjacent bundles (24), thus forming one or more outgoing bundles in which the current flows in a first direction, and one or more ingoing bundles in which the current flows in a second direction, opposite to the first one, the current flowing in the bundles (24) being able to generate, around the pattern (20) and in the body of magnetizable material (10), a magnetization magnetic field suitable for magnetizing the body of magnetizable material (10).

24. The manufacturing method according to claim 23, characterized in that the disposition of the parallel electrical conductors (22) in each bundle is identical by means of a rotation, between two angularly consecutive bundles (24), by an angle equal to 360 degrees of angle divided by the number of bundles (24).

25. The manufacturing method according to claim 23, characterized in that, in a given bundle (24), the parallel electrical conductors (22) of the bundle (24) are angularly distributed uniformly about the main axis (A′).

26. The manufacturing method according to claim 23, characterized in that, in a given bundle (24), the parallel electrical conductors (22) of the bundle (24) are distributed over an arc of a circle centered on the main axis (A′) or on several concentric arcs of a circle centered on the main axis (A′).

27. The manufacturing method according to claim 23, characterized in that, in a given bundle (24), each parallel electrical conductor (22) of the bundle (24) has a length along the axis of rotation equal to at least 4 times the length of the body of the magnetizable material (10).

28. The manufacturing method according to claim 23, characterized in that the parallel electrical conductors (22) of the bundles (24) are formed by portions of at least one winding of a conductive wire along which at least one conductor of an outgoing bundle, a connecting portion and a conductor of an ingoing bundle, another connecting portion and another conductor of an outgoing bundle, repeatedly follow each other.

29. The manufacturing method according to claim 23, characterized in that the body of magnetizable material (10) is a body in the form of a tubular portion of revolution about the main axis (A′).

30. The manufacturing method according to claim 23, characterized in that the body of magnetizable material (10) is a body in the form of a cylindrical tubular portion about the main axis (A′).
